(19) United States
(12) Patent Application Publication
(10) Pub. No.: US 2026/0353399 A1
(43) Pub. Date: Nov. 5, 2026

(54) MULTIPLE TRANSMISSION RECEPTION POINT COHERENT JOINT TRANSMISSION PHYSICAL DOWNLINK SHARED CHANNEL OPERATIONS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/099,967

(22) PCT Filed: Sep. 28, 2022
(86) PCT No.: PCT/CN2022/122069

§ 371 Date: Jan. 30, 2025

(51) Int. Cl. H04W 72/23; H04W 72/11

(52) U.S. Cl. CPC H04W 72/23; H04W 72/11

(57) ABSTRACT

Various aspects of the present disclosure generally relate to wireless communication. In some aspects, a user equipment (UE) may receive configuration information associated with a multiple transmission reception point (mTRP) coherent joint transmission (CJT) physical downlink shared channel (PDSCH) operation, wherein the configuration information is indicative of one or more unified transmission configuration indicators (TCIs). The UE may receive, based on the one or more unified TCIs, a CJT communication comprising a plurality of transmission layers, wherein each transmission layer of the plurality of transmission layers corresponds to each of the one or more unified TCIs. Numerous other aspects are described.

### INTRODUCTION

Aspects of the present disclosure generally relate to wireless communication and to techniques and apparatuses for coherent downlink channel operations.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive configuration information associated with a multiple transmission reception point (mTRP) coherent joint transmission (CJT) physical downlink shared channel (PDSCH) operation, wherein the configuration information is indicative of one or more unified transmission configuration indicators (TCIs). The one or more processors may be configured to receive, based on the one or more unified TCIs, a CJT communication comprising a plurality of transmission layers, wherein each transmission layer of the plurality of transmission layers corresponds to each of the one or more unified TCIs.

Some aspects described herein relate to a network node for wireless communication. The network node may include a memory and one or more processors coupled to the memory. The one or more processors may be configured to transmit configuration information associated with an mTRP CJT PDSCH operation, wherein the configuration information is indicative of one or more unified TCIs. The one or more processors may be configured to transmit, based on the one or more unified TCIs, a CJT communication comprising a plurality of transmission layers, wherein each transmission layer of the plurality of transmission layers corresponds to each of the one or more unified TCIs.

Some aspects described herein relate to a UE for wireless communication.

The user equipment may include a memory and one or more processors coupled to the memory. The one or more processors may be configured to receive configuration information associated with an mTRP CJT physical uplink channel operation. The one or more processors may be configured to generate a layer of a CJT communication, wherein the layer of the CJT communication based on a coherent precoding scheme associated with a plurality of transmission reception points (TRPs). The one or more processors may be configured to transmit the layer of the CJT communication to the plurality of TRPs.

Some aspects described herein relate to a network node for wireless communication. The network node may include a memory and one or more processors coupled to the memory. The one or more processors may be configured to transmit configuration information associated with an mTRP CJT physical uplink channel operation. The one or more processors may be configured to receive a layer of a CJT communication, wherein the layer of the CJT communication is based on a coherent precoding scheme associated with a plurality of TRPs, and wherein the network node comprises a TRP of the plurality of TRPs.

Some aspects described herein relate to a method of wireless communication performed by an apparatus of a UE. The method may include receiving configuration information associated with an mTRP CJT PDSCH operation, wherein the configuration information is indicative of one or more unified TCIs. The method may include receiving, based on the one or more unified TCIs, a CJT communication comprising a plurality of transmission layers, wherein each transmission layer of the plurality of transmission layers corresponds to each of the one or more unified TCIs.

Some aspects described herein relate to a method of wireless communication performed by an apparatus of a network node. The method may include transmitting configuration information associated with an mTRP CJT PDSCH operation, wherein the configuration information is indicative of one or more unified TCIs. The method may include transmitting, based on the one or more unified TCIs, a CJT communication comprising a plurality of transmission layers, wherein each transmission layer of the plurality of transmission layers corresponds to each of the one or more unified TCIs.

Some aspects described herein relate to a method of wireless communication performed by an apparatus of a UE. The method may include receiving configuration information associated with an mTRP CJT physical uplink channel operation. The method may include generating a layer of a CJT communication, wherein the layer of the CJT communication based on a coherent precoding scheme associated with a plurality of TRPs. The method may include transmitting the layer of the CJT communication to the plurality of TRPs.

Some aspects described herein relate to a method of wireless communication performed by an apparatus of a network node. The method may include transmitting configuration information associated with an mTRP CJT physical uplink channel operation. The method may include receiving a layer of a CJT communication, wherein the layer of the CJT communication is based on a coherent precoding scheme associated with a plurality of TRPs, and wherein the network node comprises a TRP of the plurality of TRPs.

Some aspects described herein relate to a non-transitory computer-readable medium that stores a set of instructions for wireless communication by a UE. The set of instructions, when executed by one or more processors of the UE, may cause the UE to receive configuration information associated with an mTRP CJT PDSCH operation, wherein the configuration information is indicative of one or more unified TCIs. The set of instructions, when executed by one or more processors of the UE, may cause the UE to receive, based on the one or more unified TCIs, a CJT communication comprising a plurality of transmission layers, wherein each transmission layer of the plurality of transmission layers corresponds to each of the one or more unified TCIs.

Some aspects described herein relate to a non-transitory computer-readable medium that stores a set of instructions for wireless communication by a network node. The set of instructions, when executed by one or more processors of the network node, may cause the network node to transmit configuration information associated with an m TRP CJT PDSCH operation, wherein the configuration information is indicative of one or more unified TCIs. The set of instructions, when executed by one or more processors of the network node, may cause the network node to transmit, based on the one or more unified TCIs, a CJT communication comprising a plurality of transmission layers, wherein each transmission layer of the plurality of transmission layers corresponds to each of the one or more unified TCIs.

Some aspects described herein relate to a non-transitory computer-readable medium that stores a set of instructions for wireless communication by a UE. The set of instructions, when executed by one or more processors of the UE, may cause the UE to receive configuration information associated with an mTRP CJT physical uplink channel operation. The set of instructions, when executed by one or more processors of the UE, may cause the UE to generate a layer of a CJT communication, wherein the layer of the CJT communication based on a coherent precoding scheme associated with a plurality of TRPs. The set of instructions, when executed by one or more processors of the UE, may cause the UE to transmit the layer of the CJT communication to the plurality of TRPs.

Some aspects described herein relate to a non-transitory computer-readable medium that stores a set of instructions for wireless communication by a network node. The set of instructions, when executed by one or more processors of the network node, may cause the network node to transmit configuration information associated with an mTRP CJT physical uplink channel operation. The set of instructions, when executed by one or more processors of the network node, may cause the network node to receive a layer of a CJT communication, wherein the layer of the CJT communication is based on a coherent precoding scheme associated with a plurality of TRPs, and wherein the network node comprises a TRP of the plurality of TRPs.

Some aspects described herein relate to an apparatus for wireless communication. The apparatus may include means for receiving configuration information associated with an mTRP CJT PDSCH operation, wherein the configuration information is indicative of one or more unified TCIs. The apparatus may include means for receiving, based on the one or more unified TCIs, a CJT communication comprising a plurality of transmission layers, wherein each transmission layer of the plurality of transmission layers corresponds to each of the one or more unified TCIs.

Some aspects described herein relate to an apparatus for wireless communication. The apparatus may include means for transmitting configuration information associated with an mTRP CJT PDSCH operation, wherein the configuration information is indicative of one or more unified TCIs. The apparatus may include means for transmitting, based on the one or more unified TCIs, a CJT communication comprising a plurality of transmission layers, wherein each transmission layer of the plurality of transmission layers corresponds to each of the one or more unified TCIs.

Some aspects described herein relate to an apparatus for wireless communication. The apparatus may include means for receiving configuration information associated with an mTRP CJT physical uplink channel operation. The apparatus may include means for generating a layer of a CJT communication, wherein the layer of the CJT communication based on a coherent precoding scheme associated with a plurality of TRPs. The apparatus may include means for transmitting the layer of the CJT communication to the plurality of TRPs.

Some aspects described herein relate to an apparatus for wireless communication. The apparatus may include means for transmitting configuration information associated with an mTRP CJT physical uplink channel operation. The apparatus may include means for receiving a layer of a CJT communication, wherein the layer of the CJT communication is based on a coherent precoding scheme associated with a plurality of TRPs, and wherein the network node comprises a TRP of the plurality of TRPs.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4A is a diagram illustrating an example of multiple transmission reception point (mTRP) communication, in accordance with the present disclosure.

FIG. 4B is a diagram illustrating an example of mTRP coherent joint transmission (CJT) communications, in accordance with the present disclosure.

FIG. 5 is a diagram illustrating an example associated with coherent downlink channel operations, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram illustrating an example of a hardware implementation for an apparatus employing a processing system, in accordance with the present disclosure.

FIG. 12 is a diagram illustrating an example of an implementation of code and circuitry for an apparatus, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

### DETAILED DESCRIPTION

A user equipment (UE) may communicate with a number of transmission reception points (TRPs) using beams. A TRP is a network entity configured to transmit and receive signals. For example, a TRP may include one or more components of a base station. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

In some cases, a UE may communicate with multiple TRPs simultaneously (e.g., at the same time) in accordance with a multiple TRP (mTRP) configuration. In mTRP downlink communications, the UE may receive a number of communications, each from a different TRP. Each communication may be a spatial layer of a joint communication associated with a physical downlink shared channel (PDSCH). A joint communication is a communication that includes more than one signal that shares one or more time resources. Each TRP may be disposed at a different location than each other TRP and, as a result, each respective communication may be associated with one or more different respective spatial resources. Thus, each respective communication may be a spatial layer of the joint communication. A spatial layer of a joint communication is a portion of the joint communication that corresponds to a set of spatial resources. For example, a joint communication may include a first spatial layer corresponding to a first set of spatial resources and a second spatial layer corresponding to a second set of spatial resources.

To receive a joint communication from the multiple TRPs, a single wide beam corresponding to a single transmission configuration indicator (TCI) state can be used. However, the single wide beam can result in application of a single spatial filter that applies to all of the layers of the joint communication, which may not be coherent (e.g., the layers of the joint communication may not have respective phases such that the layers can be constructively combined at a receiving device). A spatial filter is a mechanism (e.g., a process, procedure, circuitry, and/or software, among other examples) used to direct an electromagnetic signal into a certain path. In some cases, a coherent joint transmission (CJT) configuration may be used for a coherent joint communication to facilitate more efficient application of spatial filters, which may result in fewer missed signals and more spectral efficiency.

A CJT configuration may be used for PDSCH communications, physical uplink control channel (PUCCH) communications, and/or physical uplink shared channel (PUSCH) communications. A CJT is a joint transmission in which each layer of the joint transmission is transmitted with a respective phase such that the layers can be constructively combined at a receiving device. To facilitate supporting CJTs for mTRP PDSCH and/or uplink channel communications, some aspects may provide for configuring a UE with a number of unified TCIs for a CJT transmission. A unified TCI is a TCI that indicates a unified TCI state, which is a beam indication that can be used for multiple channels and/or signals simultaneously. In some aspects, for example, the UE may obtain configuration information associated with an mTRP CJT PDSCH operation. An mTRP CJT PDSCH operation refers to an operation in which a UE receives an mTRP CJT via a PDSCH.

For example, a TCI activation medium access control control element (MAC CE) indicative of an activation of a TCI codepoint with at least one unified TCI may be used to facilitate monitoring a control resource set (CORESET) for a physical downlink control channel (PDCCH) communication. A TCI codepoint may be a value of a TCI in a downlink control information (DCI) transmission. In some aspects, a unified TCI may be selected based on a flag (e.g., a binary field) that indicates a radio resource control (RRC) configuration.

Some aspects may facilitate semi-persistent scheduling (SPS) PDSCH reception using CJT. SPS PDSCH reception refers to reception of downlink signals in reception occasions that are configured to be repeated in accordance with a configuration. For example, when a UE is configured with a quantity, X, unified TCIs for each layer of CJT PDSCH in mTRP operations, for SPS PDSCH reception that was previously associated with a quantity, Z, unified TCIs, the UE may apply all X of the new unified TCIs for SPS PDSCH, regardless of the values of X and Z. In another example, the UE may ignore the X new TCIs and still apply the Z unified TCIs for SPS PDSCH. In another example, the UE may apply the same number of TCIs (e. g,. Z). For example, if Z=<X, the UE may select Z TCIs out of the X newly-indicated TCIs for SPS PDSCH (e.g., the first Z unified TCIs). In another example, if Z>X, the UE may apply the Z old TCIs for SPS PDSCH. In another example, the UE may apply a default TCI codepoint (e.g., a TCI codepoint with a lowest ID of Z TCIs).

In some aspects, a UE may be configured to switch between a CJT communication scheme (e.g., a communication mode in which CJT communications are transmitted and/or received) and another type of communication scheme. For example, the UE may monitor a PDSCH based on a first communication scheme during a first time period and monitor the PDSCH based on a second communication scheme during a second time period based on a switching condition being satisfied. The first communication scheme or the second communication scheme may correspond to at least one of a time division multiplexing (TDM) mTRP operation, a spatial division multiplexing (SDM) mTRP operation, or a single frequency network (SFN) operation. In some examples, the UE may be configured to switch communication schemes based on an RRC configuration based switch and/or a MAC CE based switch.

In this way, multiple beams (where each beam corresponds to a respective TCI) may be used to receive CJT PDSCH communications from multiple TRPs and/or to transmit CJT PUCCH and/or PUSCH communications. Since each TRP is associated with a respective beam, each layer of a CJT PDSCH communication may be associated with a unique spatial filter. Additionally, to facilitate CJT, in some aspects, each layer of a CJT PDSCH communication may be received using each indicated unified TCI.

In some aspects, a coherent precoding scheme may be used to facilitate CJT mTRP PUSCH operations. A CJT mTRP PUSCH operation is an operation in which a UE transmits a CJT mTRP communication via a PUSCH. A precoding scheme may include a set of precoders for use in precoding respective layers of a joint communication. In some cases, each layer can be precoded using a same precoder as each other layer. However, due to spatial variation between the layers, using the same precoder for all of the layers can result in non-coherent joint communications. In some aspects, a coherent precoding scheme may be used to facilitate transmitting a CJT. For example, each layer of a CJT PUSCH communication may be precoded using a respective precoder that is configured such that the layers of the CJT communication may be transmitted coherently.

In this way, some aspects may facilitate implementation of single-DCI-based CJT for mTRP operations and, as a result, may improve throughput and/or spectral efficiency, thereby positively impacting network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

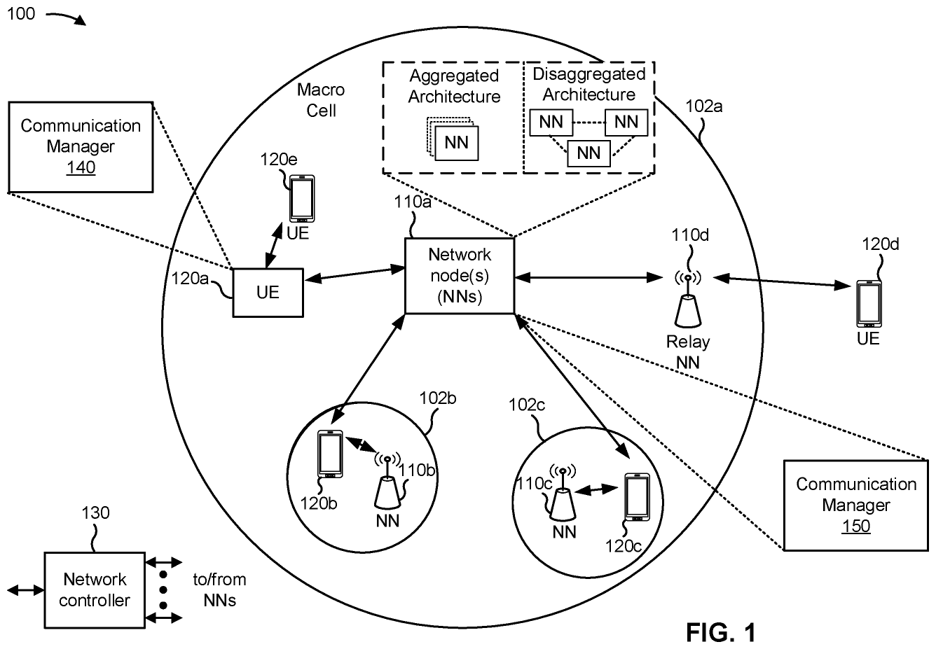

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information associated with an mTRP CJT PDSCH operation, wherein the configuration information is indicative of one or more unified TCIs; and receive, based on the one or more unified TCIs, a CJT communication comprising a plurality of transmission layers, wherein each transmission layer of the plurality of transmission layers corresponds to each of the one or more unified TCIs.

In some aspects, the communication manager 140 may receive configuration information associated with an mTRP CJT physical uplink channel operation; generate a layer of a CJT communication, wherein the layer of the CJT communication based on a coherent precoding scheme associated with a plurality of TRPs; and transmit the layer of the CJT communication to the plurality of TRPs. Additionally, or alternatively, the communication manager 140 may perform one or more other operations described herein.

In some aspects, the network node 110 may include a communication manager 150. As described in more detail elsewhere herein, the communication manager 150 may transmit configuration information associated with an mTRP CJT PDSCH operation, wherein the configuration information is indicative of one or more unified TCIs; and transmit, based on the one or more unified TCIs, a CJT communication comprising a plurality of transmission layers, wherein each transmission layer of the plurality of transmission layers corresponds to each of the one or more unified TCIs.

In some aspects, the communication manager 150 may transmit configuration information associated with an mTRP CJT physical uplink channel operation; and receive a layer of a CJT communication, wherein the layer of the CJT communication is based on a coherent precoding scheme associated with a plurality of TRPs, and wherein the network node comprises a TRP of the plurality of TRPs. Additionally, or alternatively, the communication manager 150 may perform one or more other operations described herein.

As indicated above, FIG. 1 is provided as an example. Other examples may differ from what is described with regard to FIG. 1.

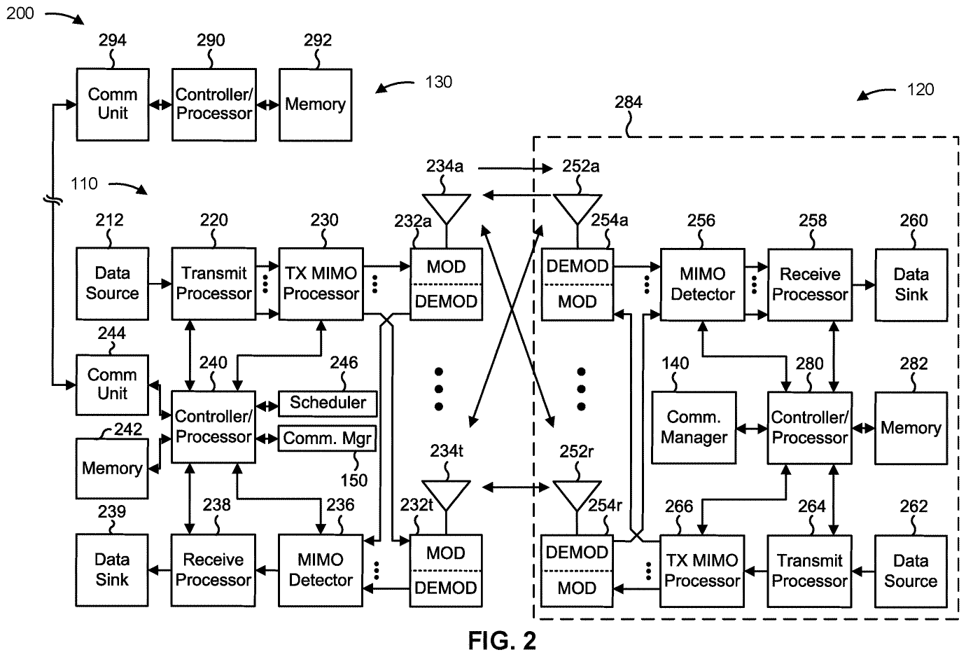

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of TCI states that respectively indicate beams that may be used by the UE, such as for receiving a PDSCH. The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

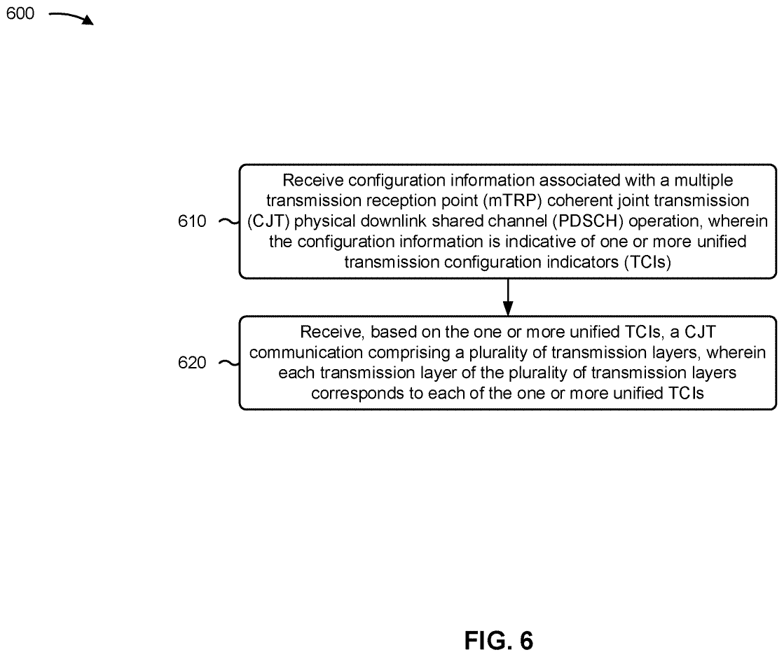

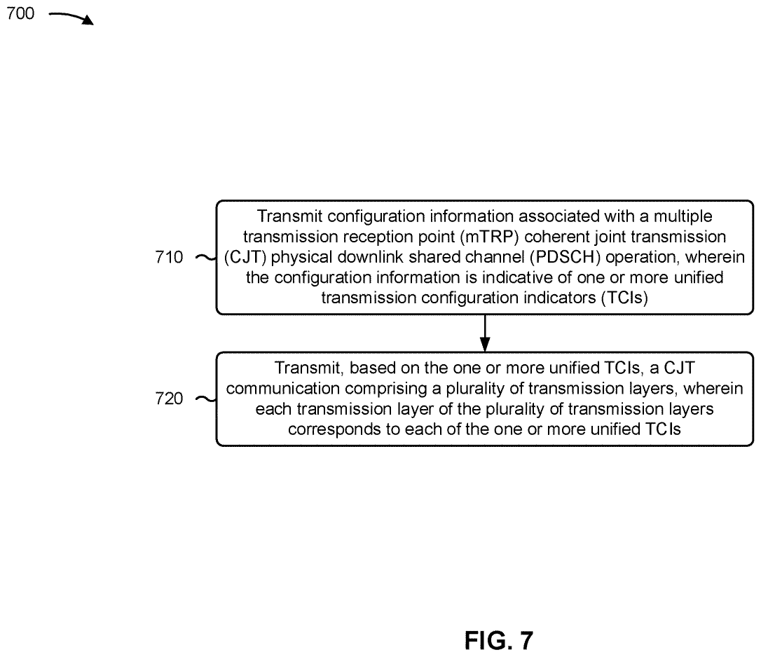

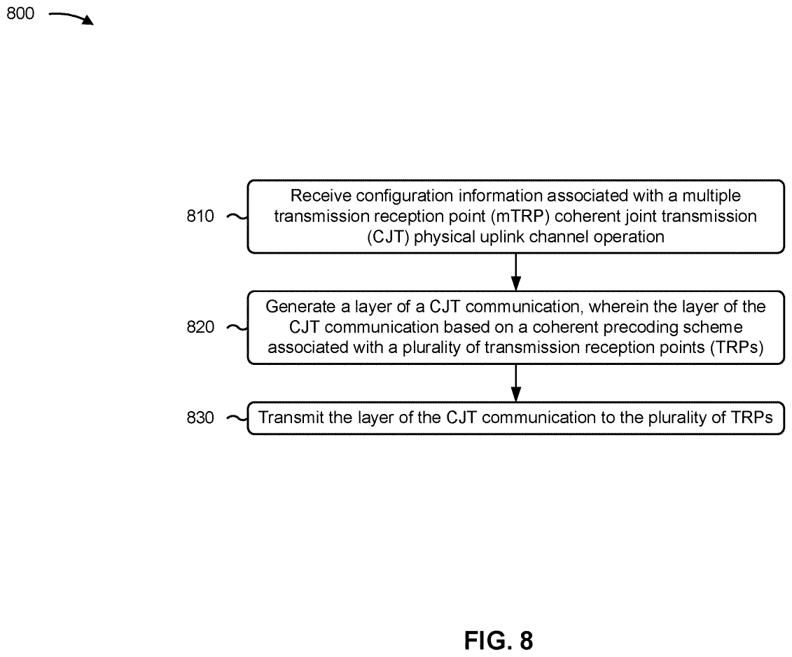

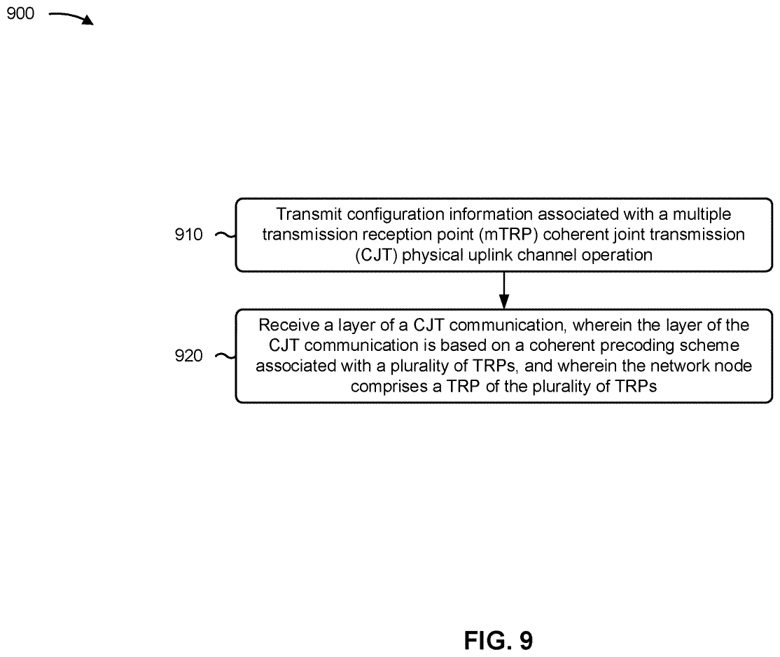

The controller/processor 240 of the network node 110, the controller/processor 280 of the UE 120, and/or any other component(s) of FIG. 2 may perform one or more techniques associated with coherent downlink channel operations, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving configuration information associated with an mTRP CJT PDSCH operation, wherein the configuration information is indicative of one or more unified TCIs; and/or means for receiving, based on the one or more unified TCIs, a CJT communication comprising a plurality of transmission layers, wherein each transmission layer of the plurality of transmission layers corresponds to each of the one or more unified TCIs.

In some aspects, the UE 120 includes means for receiving configuration information associated with an mTRP CJT physical uplink channel operation; means for generating a layer of a CJT communication, wherein the layer of the CJT communication based on a coherent precoding scheme associated with a plurality of TRPs; and/or means for transmitting the layer of the CJT communication to the plurality of TRPs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information associated with an mTRP CJT PDSCH operation, wherein the configuration information is indicative of one or more unified TCIs; and/or means for transmitting, based on the one or more unified TCIs, a CJT communication comprising a plurality of transmission layers, wherein each transmission layer of the plurality of transmission layers corresponds to each of the one or more unified TCIs. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node 110 includes means for transmitting configuration information associated with an mTRP CJT physical uplink channel operation; and/or means for receiving a layer of a CJT communication, wherein the layer of the CJT communication is based on a coherent precoding scheme associated with a plurality of TRPs, and wherein the network node comprises a TRP of the plurality of TRPs. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

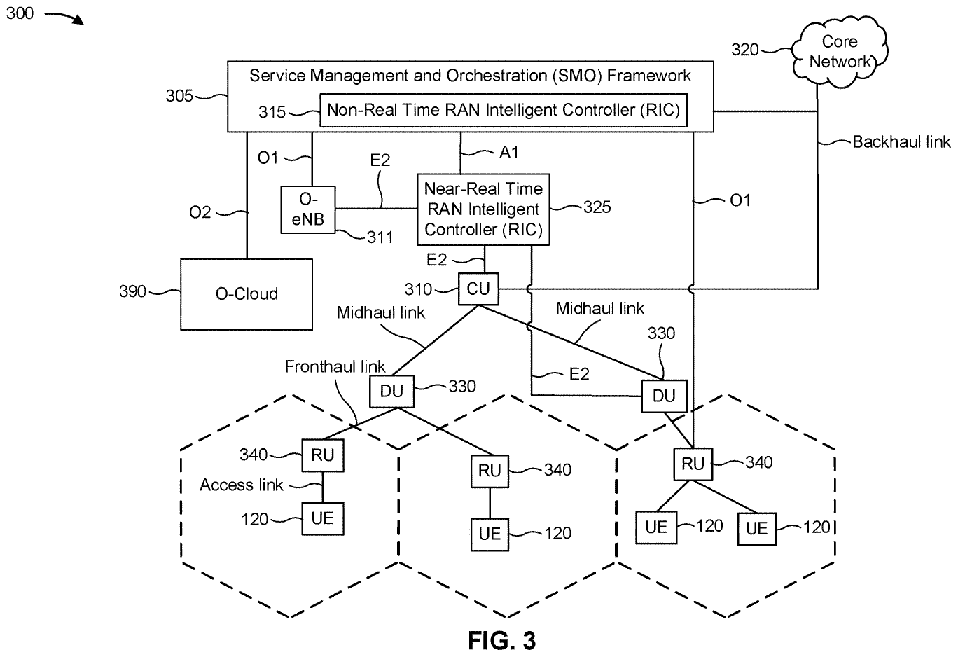

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

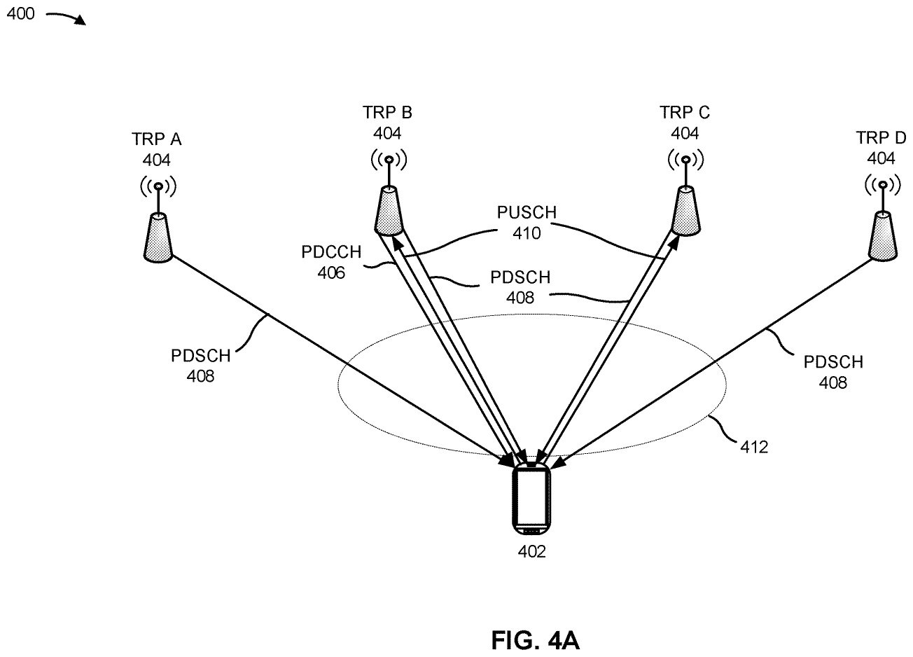

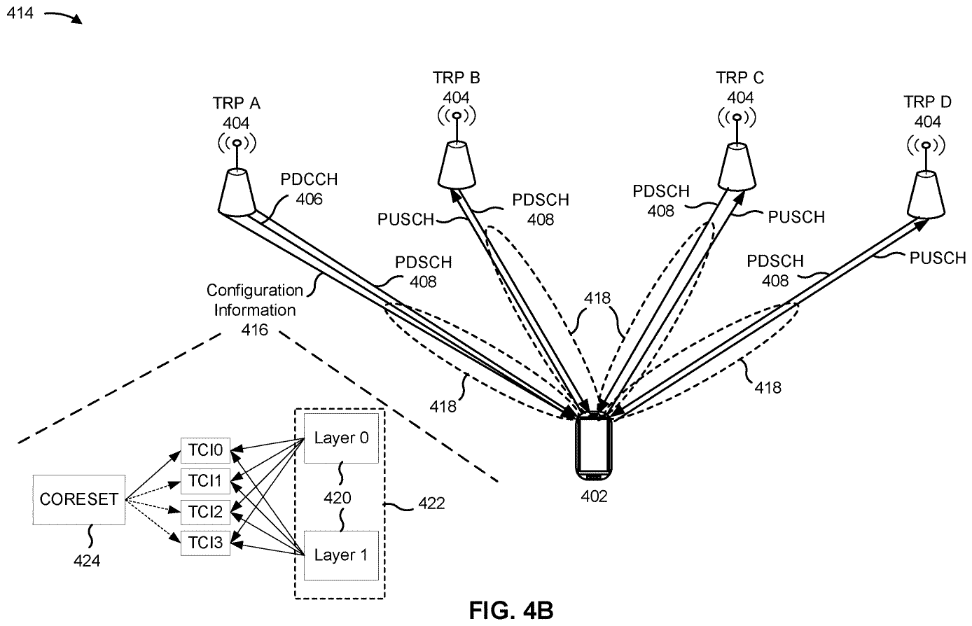

FIG. 4A is a diagram illustrating an example 400 of mTRP communication (sometimes referred to as multi-panel communication), in accordance with the present disclosure. As shown in FIG. 4A, a UE 402 may communicate with multiple TRPs 404. A network node (e.g., network node 110) may include multiple TRPs 404, or multiple TRPs 404 may be distributed across multiple network nodes.

The multiple TRPs 404 (shown as TRP A, TRP B, TRP C, and TRP D) may communicate with the same UE 402 in a coordinated manner (e.g., using coordinated multipoint transmissions) to improve reliability and/or increase throughput. The TRPs 404 may coordinate such communications via an interface between the TRPs 404 (e.g., a backhaul interface and/or an access node controller). The interface may have a smaller delay and/or higher capacity when the TRPs 404 are co-located at the same network node (e.g., when the TRPs 404 are different antenna arrays or panels of the same network node), and may have a larger delay and/or lower capacity (as compared to co-location) when the TRPs 404 are located at different network nodes. The different TRPs 404 may communicate with the UE 402 using different QCL relationships (e.g., different TCI states), different DMRS ports, and/or different layers (e.g., of a multi-layer communication).

In some cases, a single physical downlink control channel (PDCCH) 406 may be used to schedule downlink data communications for a single PDSCH 408. In some cases, the PDCCH 406 may be used to schedule a PUSCH 410. In some cases, multiple TRPs 404 (e.g., TRP A and TRP B) may transmit communications to the UE 402 on the same PDSCH 408. For example, a joint communication may be transmitted using a single codeword with different spatial layers for different TRPs 404 (e.g., where one codeword maps to a first set of layers transmitted by a first TRP 404 and maps to a second set of layers transmitted by a second TRP 404). As another example, a communication may be transmitted using multiple codewords, where different codewords are transmitted by different TRPs 404 (e.g., using different sets of layers). In either case, different TRPs 404 may use different QCL relationships (e.g., different TCI states) for different DMRS ports corresponding to different layers. For example, a first TRP 404 may use a first QCL relationship or a first TCI state for a first set of DMRS ports corresponding to a first set of layers, and a second TRP 404 may use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in multi-TRP transmission.

For mTRP PDSCH transmission, in some cases, a single TCI state can be used for all of the TRPs 404. In this case, for example, to receive a joint communication from TRP A, TRP B, TRP C, and TRP D, a wide beam 412 corresponding to the single TCI state can be used. However, the single wide beam can result in application of a filter that applies to all of the TRPs 404 (and, thus, layers of the communication), which may have no coherence among them. In some cases, a CJT configuration may be used to facilitate more efficient application of spatial filters, which may result in fewer missed signals and more spectral efficiency.

Some aspects of the techniques and apparatuses described herein may provide for configuring a UE with a plurality of unified TCIs for PDSCH, thereby enabling single-DCI-based CJT for mTRP PDSCH. FIG. 4B is a diagram illustrating an example 414 of mTRP CJT communications, in accordance with the present disclosure. As shown in FIG. 4B, for example, a network node (e.g., TRP A 404) may transmit, and the UE 402 may receive, configuration information 416. The configuration information 416 may be associated with an mTRP CJT PDSCH operation. The configuration information 416 may be indicative of one or more unified TCIs, each of which may correspond to a TRP 404 of the multiple TRPs 404. In this way, multiple beams 418 (where each beam 418 corresponds to a respective TCI) may be used to receive CJT PDSCH communications in mTRP. Since each TRP 404 is associated with a respective beam 418, each layer 420 (shown as “Layer 0″ and ”Layer 1″) of a CJT PDSCH communication 422 may be associated with a unique spatial filter. In some aspects, a coherent precoding scheme may be used to facilitate CJT mTRP PUSCH operations. In this way, some aspects may facilitate implementation of single-DCI-based CJT for mTRP operations and, as a result, may improve throughput and/or spectral efficiency, thereby positively impacting network performance.

In some aspects, for example, to enable single-DCI-based CJT for mTRP operations, the UE 402 may be indicated with up to X unified TCIs for PDSCH, where each layer and/or DMRS antenna port of PDSCH is received using the multiple indicated unified TCIs. For example, as shown, the layer 0 may be received using each of TCI 0, TCI 1, TCI 2, and TCI 3, and the layer 1 may be received using each of TCI 0, TCI 1, TCI 2, and TCI 3. In some aspects, the configuration information 416 may include a TCI activation medium access control (MAC) control element (CE)(MAC CE), in which a TCI codepoint may be activated with up to X joint TCIs, up to X downlink TCIs, or up to X unified TCIs, where each unified TCI may be either a joint TCI or a downlink TCIs. In some aspects, a maximum value of X for CJT PDSCH may be a UE capability (e.g., X=4). In some aspects, each TCI may be associated with a respective coherent per-TRP downlink precoder.

In aspects in which the UE 402 is indicated with multiple (X>1) unified TCIs for each layer of CJT PDSCH in mTRP operations, to receive PDCCH in a control resource set (CORESET) 424, the UE 402 may perform a first operation in which the UE 402 may select one TCI for the corresponding CORESET 424. For example, the UE 402 may select the first TCI of X unified TCIs or may select the TCI based on an RRC flag included in TCI. In some aspects, the UE 402 may perform a second operation, instead of the first operation, in which the UE 402 may apply all the unified TCIs for PDCCH reception. In a third operation, the UE 402 may perform the first operation or the second operation, based on an RRC configuration ‘CJTforPDCCH’ to the corresponding CORESET 424 or to all CORESETs. In a fourth operation, the UE 402 may apply a separately indicated TCI, if the corresponding CORESET 424 is not configured to share the indicated unified TCI.

In some aspects, when a UE 402 is indicated with X unified TCIs for each layer of CJT PDSCH in mTRP operations, for semi-persistent scheduling (SPS) PDSCH reception which was previously applied with Z unified TCIs, the UE 402 may apply all the new X unified TCIs for SPS PDSCH, regardless the value of X and Z, ignore the new X TCIs and still apply the old Z unified TCIs for SPS PDSCH, or keep the same quantity of TCIs for SPS PDSCH. In the latter aspects, if Z=<X, the UE 402 may select Z TCIs out of X newly-indicated TCIs for SPS PDSCH (e.g., the first Z unified TCIs) and, if Z>X, the UE 402 may apply the old Z TCIs for SPS PDSCH. In some aspects, the UE 402 may apply a default TCI codepoint (e.g., a TCI codepoint with a lowest ID of Z TCIs).

In some aspects, the configuration information 416 may facilitate switching between CJT and another mTRP scheme. The other mTRP scheme may include a time division multiplexing (TDM), a spatial division multiplexing (SDM) or a single frequency network (SFN) for PDSCH. The switch may include an RRC configuration based switch in which only one mTRP scheme (CJT/TDM/SDM/SFN) can be enabled by RRC or a MAC CE activation based switch. Two mTRP schemes may be enabled by RRC, e.g., both CJT and SDM may be configured for enhanced mobile broadband (EMBB) services, and one can be selected by MAC CE. For example, in some aspects, an additional bit may be included in a TCI activation MAC CE to indicate whether CJT or the other mTRP scheme is applied when two TCIs are activated for a TCI codepoint. In some aspects, CJT may be applied if >2 TCIs are activated for a TCI codepoint; otherwise, the other mTRP scheme may be applied.

In some aspects, a UE 402 may be configured with CJT for PUSCH/PUCCH, where a layer of PUSCH/PUCCH may be coherently precoded across multiple TRPs 404. In FR1, in some aspects, the UE 402 may only be indicated with multiple downlink TCIs for downlink, and no TCI may be applied for uplink CJT. Per-TRP power control parameters may be linked to per-TRP SRS resource indicator (SRI) indications if supported. In some aspects, the UE 402 may be indicated with up to Y unified TCIs for uplink CJT (e.g., either joint or uplink TCIs). Joint or uplink TCI may provide power control settings (a received power target (Po), closed loop index, and/or a fractional power control factor (a)) and a pathloss reference signal indicator for per-TRP power control associated with a corresponding TRP 404, and the UE 402 may ignore QCL info in TCI.

For FR2, a UE 402 can be indicated by up to Y joint or uplink TCIs for PUSCH/PUCCH. The maximum value of Y TCIs/per-TRP power controls for CJT may be a UE capability. For example, Y may be 2 or 4, and the quantity of closed loop indexes may need to be increased for Y>2. When supporting unified TCIs for uplink, the UE 402 may be indicated with X downlink TCIs for downlink CJT and Y uplink TCIs for uplink CJT. In some aspects, the UE 402 may be indicated with Y joint TCIs for downlink and/or uplink and additional X−Y downlink TCIs for downlink CJT. In some aspects, the UE 402 may be indicated with X joint TCIs for both downlink and uplink CJT. When the UE 402 supports only Y per-TRP power control indications for uplink, but is indicated with X>Y joint TCIs for downlink, the UE 402 may select Y out of X joint TCIs for uplink CJT or expect only Y out of X joint TCIs having power control parameters.

As indicated above, FIGS. 4A and 4B are provided as examples. Other examples may differ from what is described with regard to FIGS. 4A and 4B.

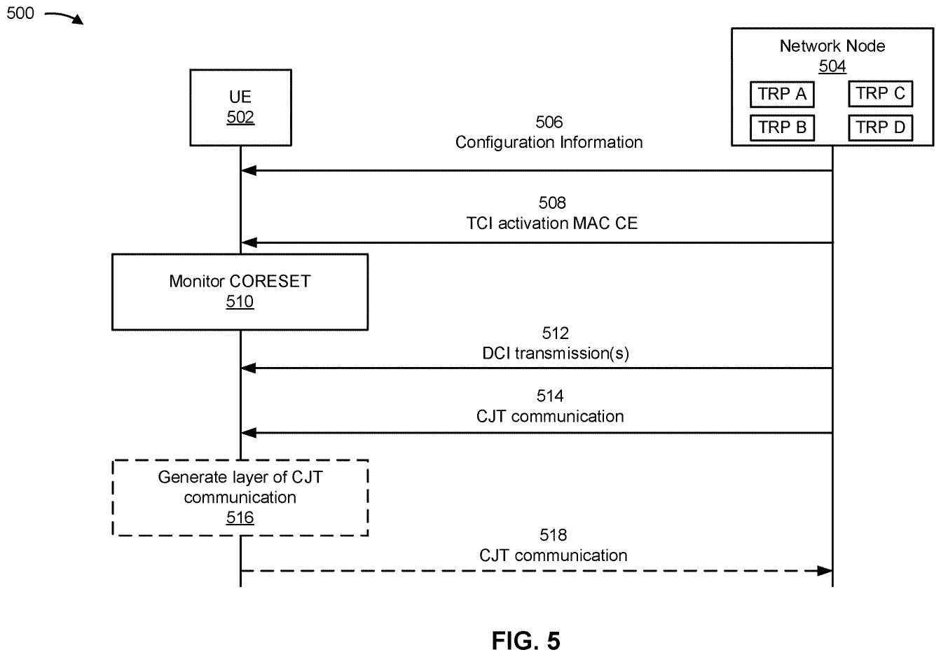

FIG. 5 is a diagram illustrating an example 500 associated with coherent downlink channel operations, in accordance with the present disclosure. As shown, example 500 may include a UE 502 and a network node 504 in communication with one another. The network node 504 may include any number of TRPs (shown as “TRP A,” “TRP B,” “TRP C,” and “TRP D”). The TRPs may be co-located and/or distributed. In some aspects, the network node 504 may include a TRP A, a TRP B, a TRP C, and a TRP D, as shown. In some other aspects, one or more of the TRP A, a TRP B, a TRP C, and a TRP D may be in different locations than the network node 504 and, in some cases, may be independent of the network node 504. The UE 502 may be, be similar to, include, or be included in, the UE 402 depicted in FIGS. 4A and 4B and/or the UE 120 depicted in FIGS. 1-3. The network node 504 may be, be similar to, include, or be included in, the TRPs 404 depicted in FIG. 4, the network node 110 depicted in FIGS. 1 and 2, and/or one or more components of the disaggregated base station architecture 300 depicted in FIG. 3.

As shown by reference number 506, the network node 504 may transmit, and the UE 502 may receive, configuration information. In some aspects, the configuration information may be associated with an mTRP CJT PDSCH operation. The configuration information may be indicative of one or more unified TCIs. In some aspects, the configuration information may include an RRC configuration and/or any other type of configuration or indication configured to facilitate the mTRP CJT PDSCH operation.

As shown by reference number 508, the network node 504 may transmit, and the UE 502 may receive, a TCI activation MAC CE. The TCI activation MAC CE may include an activation indicator corresponding to at least one codepoint mapped to at least one of a plurality of TCI states. For example, the TCI activation MAC CE may be indicative of an activation of a TCI codepoint with at least one TCI of the one or more unified TCIs. In some aspects, the at least one codepoint comprises a single codepoint. In some aspects, the mTRP configuration may include the TCI activation MAC CE. In some aspects, to support a codepoint mapped to a plurality of TCI states, the UE 502 may be configured with a channel state information (CSI) report to report one or more pairs of beams that can be simultaneously received or transmitted.

In some aspects, at least one TCI may include at least one of a joint TCI or a downlink TCI. In some aspects, a quantity of the at least one TCI may be less than or equal to a maximum TCI quantity. In some aspects, the UE 502 may transmit, and the network node 504 may receive, UE capability information indicative of the maximum TCI quantity.

As shown by reference number 510, the UE 502 may monitor, based on at least one unified TCI of the one or more unified TCIs, a CORESET for a PDCCH communication. The at least one unified TCI may include a first TCI of a plurality of unified TCIs. For example, the UE 502 may select a first TCI of the plurality of unified TCIs. In some aspects, the at least one unified TCI may be based on an RRC flag indicated by the at least one unified TCI. In some aspects, the at least one unified TCI may include each unified TCI of the one or more unified TCIs. In some aspects, the configuration information may indicate at least one unified TCI of the one or more unified TCIs for monitoring a control resource set CORESET for a PDCCH communication, and the UE 502 may monitor, based on the CORESET being configured to be monitored independently of the at least one unified TCI (e.g., based on the CORESET not being configured to share the at least one unified TCI), the CORESET based on at least one indicated TCI other than the at least one unified TCI.

As shown by reference number 512, the network node 504 may transmit, and the UE 502 may receive, one or more DCI transmissions. In some aspects, the mTRP configuration may correspond to a single downlink control information (sDCI) operation. In some aspects, for example, the mTRP configuration may include a TCI mapping that includes a TCI state activation field that maps a corresponding TCI state to a referenced TCI codepoint in the DCI transmission. In some aspects, the mapping between TCI states and TCI codepoints may be indicated by higher-layer signaling, such as TCI activation MAC CE. For example, the TCI activation MAC CE may activate multiple TCI codepoints, and the DCI may indicate a TCI codepoint selected from the multiple TCI codepoints to the UE 502.

As shown by reference number 514, the network node 504 (e.g., via two or more of TRP A, TRP B, TRP C, or TRP D) may transmit, and the UE 502 may receive, a CJT communication. The network node 504 may transmit, and the UE 502 may receive, the CJT communication based on the one or more unified TCIs. The CJT communication may include a plurality of transmission layers. Each transmission layer of the plurality of transmission layers may correspond to each of the one or more unified TCIs.

In some aspects, the network node 504 may transmit, and the UE 502 may receive, the CJT communication based on transmitting or receiving, respectively, a first SPS PDSCH communication. The one or more unified TCIs may include a first set of TCIs consisting of a first quantity of TCIs. The network node 504 may transmit, and the UE 502 may receive, additional configuration information indicative of a second set of TCIs for the mTRP CJT PDSCH operation. The second set of TCIs may consist of a second quantity of TCIs. In some aspects, the network node 504 may transmit, and the UE 502 may receive, a second SPS PDSCH communication based on the second set of TCIs. In some aspects, the network node 504 may transmit, and the UE 502 may receive, the second SPS PDSCH communication based on the first set of TCIs.

In some aspects, the network node 504 may transmit, and the UE 502 may receive, receive a second SPS PDSCH communication based on a third set of TCIs, where the third set of TCIs consists of the first quantity of TCIs. In some aspects, the third set of TCIs may include, based on the first quantity being less than or equal to the second quantity, a subset of the second set of TCIs, where the subset of the second set of TCIs consists of the first quantity of TCIs. In some aspects, the third set of TCIs may include the first set of TCIs based on the first quantity being greater than the second quantity. In some aspects, the UE 502 may receive the second SPS PDSCH communication based on a default TCI codepoint.

In some aspects, the UE 502 may receive the CJT communication based on monitoring a PDSCH for a time period. For example, the UE 502 may monitor a PDSCH based on a first communication scheme during a first time period and monitor the PDSCH based on a second communication scheme during a second time period based on a switching condition being satisfied. The first communication scheme or the second communication scheme may correspond to the mTRP CJT PDSCH operation and the other of the first communication scheme or the second communication scheme may correspond to at least one of a TDM mTRP operation, an SDM mTRP operation, or an SFN operation.

In some aspects, the UE 502 may be configured with CJT for uplink communications such as PUSCH communications and/or PUCCH communications. A layer of a PUSCH and/or PUCCH communications may be coherently precoded across multiple TRPs. As shown by reference number 516, the UE 502 may generate a layer of a CJT communication. The layer of the CJT communication may be based on a coherent precoding scheme associated with the plurality of TRPs. One or more other UEs may generate one or more additional layers of the CJT communication.

As shown by reference number 518, the UE 502 may transmit, and the network node 504 may receive, the layer of the CJT communication. In some aspects, the network node 504 may transmit, and the UE 502 may receive, an indication of a plurality of SRIs. Each SRI of the plurality of SRIs may correspond to a TRP of the plurality of TRP. To transmit the layer of the CJT communication, the UE 502 may be configured to transmit the layer of the CJT communication based on a plurality of sets of power control parameters, where each set of the plurality of sets of power control parameters is associated with an SRI of the plurality of SRIs. In some aspects, the configuration information may be indicative of a first set of unified TCIs for the mTRP CJT physical uplink channel operation. The first set of unified TCIs may include at least one of a joint TCI or an uplink TCI.

In some aspects, the first set of unified TCIs may be indicative of the plurality of sets of power control parameters. In some aspects, the UE 502 may transmit UE capability information indicative of a maximum value. The maximum value may correspond to a maximum quantity of TCIs or a maximum quantity of sets of power control parameters. A quantity of the first set of unified TCIs may be less than or equal to the maximum value. In some aspects, the configuration information may be further indicative of a second set of unified TCIs for an mTRP CJT physical downlink channel operation, where a quantity of unified TCIs in the second set of unified TCIs is less than or equal to a difference between the maximum value and a quantity of unified TCIs in the first set of unified TCIs.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 502) performs operations associated with coherent downlink channel operations.

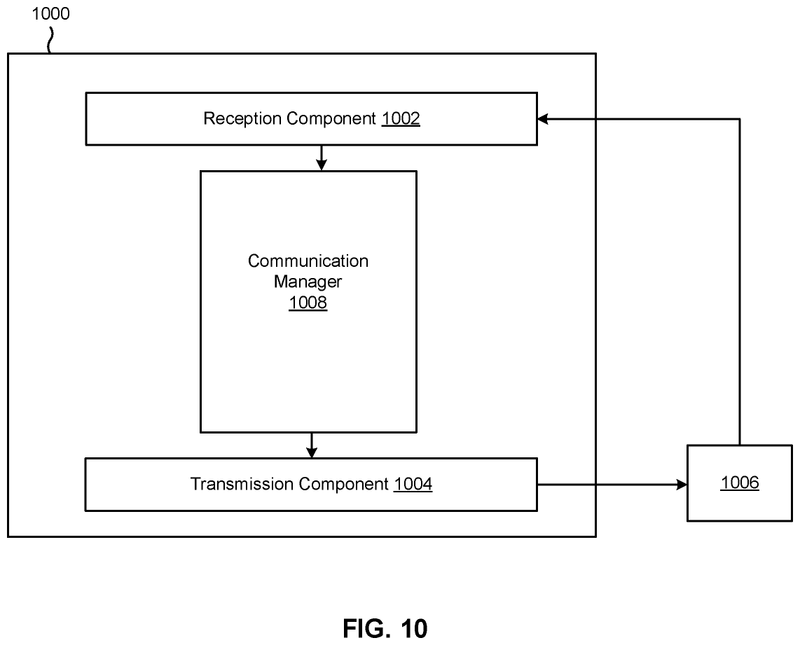

As shown in FIG. 6, in some aspects, process 600 may include receiving configuration information associated with an mTRP CJT PDSCH operation, wherein the configuration information is indicative of one or more unified TCIs (block 610). For example, the UE (e.g., using communication manager 1008 and/or reception component 1002, depicted in FIG. 10) may receive configuration information associated with an mTRP CJT PDSCH operation, wherein the configuration information is indicative of one or more unified TCIs, as described above.

As further shown in FIG. 6, in some aspects, process 600 may include receiving, based on the one or more unified TCIs, a CJT communication comprising a plurality of transmission layers, wherein each transmission layer of the plurality of transmission layers corresponds to each of the one or more unified TCIs (block 620).

For example, the UE (e.g., using communication manager 1008 and/or reception component 1002, depicted in FIG. 10) may receive, based on the one or more unified TCIs, a CJT communication comprising a plurality of transmission layers, wherein each transmission layer of the plurality of transmission layers corresponds to each of the one or more unified TCIs, as described above.

Process 600 may include additional aspects, such as any single aspect or any combination of aspects described below and/or in connection with one or more other processes described elsewhere herein.

In a first aspect, process 600 includes receiving a TCI activation MAC CE indicative of an activation of a TCI codepoint with at least one TCI of the one or more unified TCIs. In a second aspect, alone or in combination with the first aspect, the at least one TCI comprises at least one joint TCI. In a third aspect, alone or in combination with one or more of the first and second aspects, the at least one TCI comprises at least one downlink TCI. In a fourth aspect, alone or in combination with one or more of the first through third aspects, a quantity of the at least one TCI is less than or equal to a maximum TCI quantity. In a fifth aspect, alone or in combination with one or more of the first through fourth aspects, process 600 includes transmitting UE capability information indicative of the maximum TCI quantity.

In a sixth aspect, alone or in combination with one or more of the first through fifth aspects, process 600 includes monitoring, based on at least one unified TCI of the one or more unified TCIs, a CORESET for a PDCCH communication. In a seventh aspect, alone or in combination with one or more of the first through sixth aspects, the at least one unified TCI comprises a first TCI of a plurality of unified TCIs. In an eighth aspect, alone or in combination with one or more of the first through seventh aspects, the at least one unified TCI is based on an RRC flag indicated by the at least one unified TCI. In a ninth aspect, alone or in combination with one or more of the first through eighth aspects, the at least one unified TCI comprises each unified TCI of the one or more unified TCIs. In a tenth aspect, alone or in combination with one or more of the first an RRC radio resource control configuration indication.

In an eleventh aspect, alone or in combination with one or more of the first through tenth aspects, the configuration information indicates at least one unified TCI of the one or more unified TCIs for monitoring a CORESET for a PDCCH communication, the method further comprising monitoring, based on the CORESET being configured to be monitored independently of the at least one unified TCI, the CORESET based on at least one indicated TCI other than the at least one unified TCI. In a twelfth aspect, alone or in combination with one or more of the first through eleventh aspects, receiving the CJT communication comprises receiving a first SPS PDSCH communication, wherein the one or more unified TCIs comprises a first set of TCIs, the first set of TCIs consisting of a first quantity of TCIs, the method further comprising receiving additional configuration information indicative of a second set of TCIs for the mTRP CJT PDSCH operation, the second set of TCIs consisting of a second quantity of TCIs, and receiving a second SPS PDSCH communication based on the second set of TCIs.

In a thirteenth aspect, alone or in combination with one or more of the first through twelfth aspects, receiving the CJT communication comprises receiving a first SPS PDSCH communication, wherein the one or more unified TCIs comprises a first set of TCIs, the first set of TCIs consisting of a first quantity of TCIs, the method further comprising receiving additional configuration information indicative of a second set of TCIs for the mTRP CJT PDSCH operation, the second set of TCIs consisting of a second quantity of TCIs, and receiving a second SPS PDSCH communication based on the first set of TCIs.

In a fourteenth aspect, alone or in combination with one or more of the first through thirteenth aspects, receiving the CJT communication comprises receiving a first SPS PDSCH communication, wherein the one or more unified TCIs comprises a first set of TCIs, the first set of TCIs consisting of a first quantity of TCIs, the method further comprising receiving additional configuration information indicative of a second set of TCIs for the mTRP CJT PDSCH operation, the second set of TCIs consisting of a second quantity of TCIs, and receiving a second SPS PDSCH communication based on a third set of TCIs, wherein the third set of TCIs consists of the first quantity of TCIs.

In a fifteenth aspect, alone or in combination with one or more of the first through fourteenth aspects, the third set of TCIs comprises, based on the first quantity being less than or equal to the second quantity, a subset of the second set of TCIs, wherein the subset of the second set of TCIs consists of the first quantity of TCIs. In a sixteenth aspect, alone or in combination with one or more of the first through fifteenth aspects, the third set of TCIs comprises the first set of TCIs based on the first quantity being greater than the second quantity. In a seventeenth aspect, alone or in combination with one or more of the first through sixteenth aspects, receiving the second SPS PDSCH communication comprises receiving the second SPS PDSCH communication based on a default TCI codepoint. In an eighteenth aspect, alone or in combination with one or more of the first through seventeenth aspects, the default TCI codepoint is a TCI codepoint, of a plurality of TCI codepoints, associated with a ID value of a plurality of ID values corresponding to of the second set of TCIs.

In a nineteenth aspect, alone or in combination with one or more of the first through eighteenth aspects, process 600 includes monitoring a PDSCH based on a first communication scheme during a first time period, and monitoring the PDSCH based on a second communication scheme during a second time period based on a switching condition being satisfied. In a twentieth aspect, alone or in combination with one or more of the first through nineteenth aspects, the first communication scheme or the second communication scheme corresponds to the mTRP CJT PDSCH operation. In a twenty-first aspect, alone or in combination with one or more of the first through twentieth aspects, the first communication scheme or the second communication scheme corresponds to at least one of a time division multiplexing mTRP operation, a spatial division multiplexing mTRP operation, or a single frequency network operation. In a twenty-second aspect, alone or in combination with one or more of the first through twenty-first aspects, receiving the configuration information comprises receiving an RRC message, and wherein the switching condition is satisfied based on the RRC message.

In a twenty-third aspect, alone or in combination with one or more of the first through twenty-second aspects, process 600 includes receiving a TCI activation MAC CE, wherein the switching condition is satisfied based on the MAC CE. In a twenty-fourth aspect, alone or in combination with one or more of the first through twenty-third aspects, the configuration information configures the first communication scheme and the second communication scheme, and wherein the TCI activation MAC CE indicates the first communication scheme or the second communication scheme. In a twenty-fifth aspect, alone or in combination with one or more of the first through twenty-fourth aspects, the TCI activation MAC CE activates two TCIs of the one or more unified TCIs for a TCI codepoint, wherein the TCI activation MAC CE includes a dedicated bit that indicates the first communication scheme or the second communication scheme. In a twenty-sixth aspect, alone or in combination with one or more of the first through twenty-fifth aspects, the second communication scheme comprises the mTRP CJT PDSCH operation, and wherein the switching condition is satisfied based on the TCI activation MAC CE activating greater than two TCIs for a TCI codepoint.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 404) performs operations associated with coherent downlink channel operations.

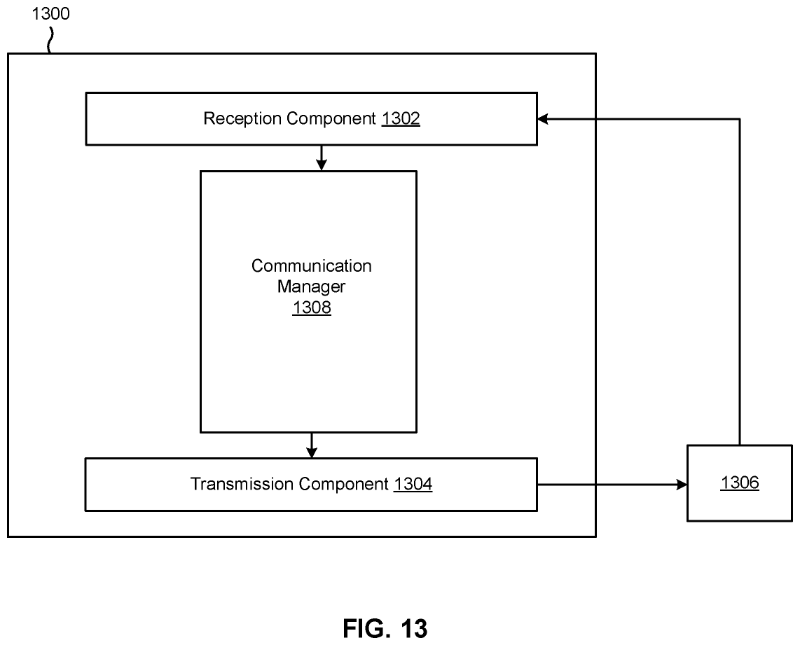

As shown in FIG. 7, in some aspects, process 700 may include transmitting configuration information associated with an mTRP CJT PDSCH operation, wherein the configuration information is indicative of one or more unified TCIs (block 710). For example, the network node (e.g., using communication manager 1308 and/or transmission component 1304, depicted in FIG. 13) may transmit configuration information associated with an mTRP CJT PDSCH operation, wherein the configuration information is indicative of one or more unified TCIs, as described above.

As further shown in FIG. 7, in some aspects, process 700 may include transmitting, based on the one or more unified TCIs, a CJT communication comprising a plurality of transmission layers, wherein each transmission layer of the plurality of transmission layers corresponds to each of the one or more unified TCIs (block 720). For example, the network node (e.g., using communication manager 1308 and/or transmission component 1304, depicted in FIG. 13) may transmit, based on the one or more unified TCIs, a CJT communication comprising a plurality of transmission layers, wherein each transmission layer of the plurality of transmission layers corresponds to each of the one or more unified TCIs, as described above.

Process 700 may include additional aspects, such as any single aspect or any combination of aspects described below and/or in connection with one or more other processes described elsewhere herein.

In a first aspect, process 700 includes transmitting a TCI activation MAC CE indicative of an activation of a TCI codepoint with at least one TCI of the one or more unified TCIs. In a second aspect, alone or in combination with the first aspect, the at least one TCI comprises at least one joint TCI. For example, the TCI codepoint may include multiple joint TCIs. In a third aspect, alone or in combination with one or more of the first and second aspects, the at least one TCI comprises at least one downlink TCI. For example, the TCI codepoint may include multiple downlink TCIs. In a fourth aspect, alone or in combination with one or more of the first through third aspects, a quantity of the at least one TCI is less than or equal to a maximum TCI quantity. In a fifth aspect, alone or in combination with one or more of the first through fourth aspects, process 700 includes receiving UE capability information indicative of the maximum TCI quantity. For example, UE capability information indicative of the maximum TCI quantity may be four.

In a sixth aspect, alone or in combination with one or more of the first through fifth aspects, the configuration information corresponds to a monitoring, operation based on at least one unified TCI of the one or more unified TCIs, associated with a CORESET for a PDCCH communication. In a seventh aspect, alone or in combination with one or more of the first through sixth aspects, the at least one unified TCI comprises a first TCI of a plurality of unified TCIs. In an eighth aspect, alone or in combination with one or more of the first through seventh aspects, the at least one unified TCI is based on an RRC flag indicated by the at least one unified TCI. For example, the RRC flag may be configured for each CORESET to indicate one TCI of a plurality of unified TCIs to be applied for the CORESET.

In a ninth aspect, alone or in combination with one or more of the first through eighth aspects, the at least one unified TCI comprises each unified TCI of the one or more unified TCIs. In a tenth aspect, alone or in combination with one or more of the first through ninth aspects, the at least one unified TCI is based on an RRC configuration indication. In an eleventh aspect, alone or in combination with one or more of the first through tenth aspects, the configuration information indicates at least one unified TCI of the one or more unified TCIs for monitoring a CORESET for a PDCCH communication, wherein a monitoring operation is, based on the CORESET not being configured to share the at least one unified TCI, associated with the CORESET based on at least one indicated TCI other than the at least one unified TCI.

In a twelfth aspect, alone or in combination with one or more of the first through eleventh aspects, transmitting the CJT communication comprises transmitting a first SPS PDSCH communication, wherein the one or more unified TCIs comprises a first set of TCIs, the first set of TCIs consisting of a first quantity of TCIs, the method further comprising transmitting additional configuration information indicative of a second set of TCIs for the mTRP CJT PDSCH operation, the second set of TCIs consisting of a second quantity of TCIs, and transmitting a second SPS PDSCH communication based on the second set of TCIs. In a thirteenth aspect, alone or in combination with one or more of the first through twelfth aspects, transmitting the CJT communication comprises transmitting a first SPS PDSCH communication, wherein the one or more unified TCIs comprises a first set of TCIs, the first set of TCIs consisting of a first quantity of TCIs, the method further comprising transmitting additional configuration information indicative of a second set of TCIs for the mTRP CJT PDSCH operation, the second set of TCIs consisting of a second quantity of TCIs, and transmitting a second SPS PDSCH communication based on the first set of TCIs.

In a fourteenth aspect, alone or in combination with one or more of the first through thirteenth aspects, transmitting the CJT communication comprises transmitting a first SPS PDSCH communication, wherein the one or more unified TCIs comprises a first set of TCIs, the first set of TCIs consisting of a first quantity of TCIs, the method further comprising transmitting additional configuration information indicative of a second set of TCIs for the mTRP CJT PDSCH operation, the second set of TCIs consisting of a second quantity of TCIs, and transmitting a second SPS PDSCH communication based on a third set of TCIs, wherein the third set of TCIs consists of the first quantity of TCIs.

In a fifteenth aspect, alone or in combination with one or more of the first through fourteenth aspects, the third set of TCIs comprises, based on the first quantity being less than or equal to the second quantity, a subset of the second set of TCIs, wherein the subset of the second set of TCIs consists of the first quantity of TCIs. In a sixteenth aspect, alone or in combination with one or more of the first through fifteenth aspects, the third set of TCIs comprises the first set of TCIs based on the first quantity being greater than the second quantity. In a seventeenth aspect, alone or in combination with one or more of the first through sixteenth aspects, transmitting the second SPS PDSCH communication comprises transmitting the second SPS PDSCH communication based on a default TCI codepoint.

In an eighteenth aspect, alone or in combination with one or more of the first through seventeenth aspects, the default TCI codepoint is a TCI codepoint, of a plurality of TCI codepoints, associated with a lowest ID value of a plurality of ID values corresponding to of the second set of TCIs. In a nineteenth aspect, alone or in combination with one or more of the first through eighteenth aspects, the configuration information is indicative of a first monitoring operation associated with a PDSCH based on a first communication scheme during a first time period, and a second monitoring operation associated with the PDSCH based on a second communication scheme during a second time period based on a switching condition being satisfied. In a twentieth aspect, alone or in combination with one or more of the first through nineteenth aspects, the first communication scheme or the second communication scheme corresponds to the mTRP CJT PDSCH operation.

In a twenty-first aspect, alone or in combination with one or more of the first through twentieth aspects, the first communication scheme or the second communication scheme corresponds to at least one of a TDM mTRP operation, an SDM mTRP operation, or an SFN operation. In a twenty-second aspect, alone or in combination with one or more of the first through twenty-first aspects, transmitting the configuration information comprises transmitting an RRC message, and wherein the switching condition is satisfied based on the RRC message.

In a twenty-third aspect, alone or in combination with one or more of the first through twenty-second aspects, process 700 includes transmitting a TCI activation MAC CE, wherein the switching condition is satisfied based on the MAC CE. In a twenty-fourth aspect, alone or in combination with one or more of the first through twenty-third aspects, the configuration information configures the first communication scheme and the second communication scheme, and wherein the TCI activation MAC CE indicates the first communication scheme or the second communication scheme. In a twenty-fifth aspect, alone or in combination with one or more of the first through twenty-fourth aspects, the TCI activation MAC CE activates two TCIs of the one or more unified TCIs for a TCI codepoint, wherein the TCI activation MAC CE includes a dedicated bit that indicates the first communication scheme or the second communication scheme. In a twenty-sixth aspect, alone or in combination with one or more of the first through twenty-fifth aspects, the second communication scheme comprises the mTRP CJT PDSCH operation, and wherein the switching condition is satisfied based on the TCI activation MAC CE activating greater than two TCIs for a TCI codepoint.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 502) performs operations associated with coherent downlink channel operations.

As shown in FIG. 8, in some aspects, process 800 may include receiving configuration information associated with an mTRP CJT physical uplink channel operation (block 810). For example, the UE (e.g., using communication manager 1008 and/or reception component 1002, depicted in FIG. 10) may receive configuration information associated with an mTRP CJT physical uplink channel operation, as described above.

As further shown in FIG. 8, in some aspects, process 800 may include generating a layer of a CJT communication, wherein the layer of the CJT communication based on a coherent precoding scheme associated with a plurality of TRPs (block 820). For example, the UE (e.g., using communication manager 1008 and/or transmission component 1004, depicted in FIG. 10) may generate a layer of a CJT communication, wherein the layer of the CJT communication based on a coherent precoding scheme associated with a plurality of TRPs, as described above.

As further shown in FIG. 8, in some aspects, process 800 may include transmitting the layer of the CJT communication to the plurality of TRPs (block 830). For example, the UE (e.g., using communication manager 1008 and/or transmission component 1004, depicted in FIG. 10) may transmit the layer of the CJT communication to the plurality of TRPs, as described above.

Process 800 may include additional aspects, such as any single aspect or any combination of aspects described below and/or in connection with one or more other processes described elsewhere herein.

In a first aspect, process 800 includes receiving an indication of a plurality of SRIs, each SRI of the plurality of SRIs corresponding to a TRP of the plurality of TRPs, wherein transmitting the layer of the CJT communication comprises transmitting the layer of the CJT communication based on a plurality of sets of power control parameters, wherein each set of the plurality of sets of power control parameters is associated with an SRI of the plurality of SRIs. In a second aspect, alone or in combination with the first aspect, the configuration information is indicative of a first set of unified TCIs for the mTRP CJT physical uplink channel operation.

In a third aspect, alone or in combination with one or more of the first and second aspects, the first set of unified TCIs include at least one of a joint TCI or an uplink TCI. In a fourth aspect, alone or in combination with one or more of the first through third aspects, transmitting the layer of the CJT communication comprises transmitting the layer of the CJT communication based on a plurality of sets of power control parameters, each set of the plurality of sets of power control parameters corresponding to a TRP of the plurality of TRPs, wherein the first set of unified TCIs are indicative of the plurality of sets of power control parameters.

In a fifth aspect, alone or in combination with one or more of the first through fourth aspects, process 800 includes transmitting UE capability information indicative of a maximum value, wherein the maximum value corresponds to a maximum quantity of TCIs or a maximum quantity of sets of power control parameters, and wherein a quantity of the first set of unified TCIs is less than or equal to the maximum value. In a sixth aspect, alone or in combination with one or more of the first through fifth aspects, the configuration information is further indicative of a second set of unified TCIs for an mTRP CJT physical downlink channel operation.

In a seventh aspect, alone or in combination with one or more of the first through sixth aspects, a quantity of unified TCIs in the second set of unified TCIs is less than or equal to a difference between the maximum value and a quantity of unified TCIs in the first set of unified TCIs. In an eighth aspect, alone or in combination with one or more of the first through seventh aspects, the maximum value corresponds to the maximum quantity of sets of power control parameters, and wherein a total quantity of TCIs in a total set of unified TCIs is greater than the maximum value, wherein the total set of unified TCIs comprises the first set of unified TCIs and the second set of unified TCIs. In a ninth aspect, alone or in combination with one or more of the first through eighth aspects, transmitting the layer of the CJT communication comprises transmitting the layer of the CJT communication based on a subset of the total set of unified TCIs, wherein a quantity of TCIs in the subset is equal to the maximum value. In a tenth aspect, alone or in combination with one or more of the first through ninth aspects, a subset of the total set of unified TCIs includes one or more TCIs indicative of the plurality of sets of power control parameters, and wherein a quantity of the one or more TCIs is equal to the maximum value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 404) performs operations associated with coherent downlink channel operations.

As shown in FIG. 9, in some aspects, process 900 may include transmitting configuration information associated with an mTRP CJT physical uplink channel operation (block 910). For example, the network node (e.g., using communication manager 1308 and/or transmission component 1304, depicted in FIG. 13) may transmit configuration information associated with an mTRP CJT physical uplink channel operation, as described above.

As further shown in FIG. 9, in some aspects, process 900 may include receiving a layer of a CJT communication, wherein the layer of the CJT communication is based on a coherent precoding scheme associated with a plurality of TRPs, and wherein the network node comprises a TRP of the plurality of TRPs (block 920). For example, the network node (e.g., using communication manager 1308 and/or reception component 1302, depicted in FIG. 13) may receive a layer of a CJT communication, wherein the layer of the CJT communication is based on a coherent precoding scheme associated with a plurality of TRPs, and wherein the network node comprises a TRP of the plurality of TRPs, as described above.

Process 900 may include additional aspects, such as any single aspect or any combination of aspects described below and/or in connection with one or more other processes described elsewhere herein.

In a first aspect, process 900 includes transmitting an indication of a plurality of SRIs, each SRI of the plurality of SRIs corresponding to a TRP of the plurality of TRPs, wherein receiving the layer of the CJT communication comprises receiving the layer of the CJT communication based on a plurality of sets of power control parameters, wherein each set of the plurality of sets of power control parameters is associated with an SRI of the plurality of SRIs. In a second aspect, alone or in combination with the first aspect, the configuration information is indicative of a first set of unified TCIs for the mTRP CJT physical uplink channel operation. In a third aspect, alone or in combination with one or more of the first and second aspects, the first set of unified TCIs include at least one of a joint TCI or an uplink TCI.

In a fourth aspect, alone or in combination with one or more of the first through third aspects, receiving the layer of the CJT communication comprises receiving the layer of the CJT communication based on a plurality of sets of power control parameters, each set of the plurality of sets of power control parameters corresponding to a TRP of the plurality of TRPs, wherein the first set of unified TCIs are indicative of the plurality of sets of power control parameters.

In a fifth aspect, alone or in combination with one or more of the first through fourth aspects, process 900 includes receiving UE capability information indicative of a maximum value, wherein the maximum value corresponds to a maximum quantity of TCIs or a maximum quantity of sets of power control parameters, and wherein a quantity of the first set of unified TCIs is less than or equal to the maximum value. In a sixth aspect, alone or in combination with one or more of the first through fifth aspects, the configuration information is further indicative of a second set of unified TCIs for an mTRP CJT physical downlink channel operation. In a seventh aspect, alone or in combination with one or more of the first through sixth aspects, a quantity of unified TCIs in the second set of unified TCIs is less than or equal to a difference between the maximum value and a quantity of unified TCIs in the first set of unified TCIs.

In an eighth aspect, alone or in combination with one or more of the first through seventh aspects, the maximum value corresponds to the maximum quantity of sets of power control parameters, and wherein a total quantity of TCIs in a total set of unified TCIs is greater than the maximum value, wherein the total set of unified TCIs comprises the first set of unified TCIs and the second set of unified TCIs. In a ninth aspect, alone or in combination with one or more of the first through eighth aspects, receiving the layer of the CJT communication comprises receiving the layer of the CJT communication based on a subset of the total set of unified TCIs, wherein a quantity of TCIs in the subset is equal to the maximum value. In a tenth aspect, alone or in combination with one or more of the first through ninth aspects, a subset of the total set of unified TCIs includes one or more TCIs indicative of the plurality of sets of power control parameters, and wherein a quantity of the one or more TCIs is equal to the maximum value.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008.

In some aspects, the apparatus 1000 may be configured to perform one or more operations described herein in connection with FIGS. 4B and 5. Additionally, or alternatively, the apparatus 1000 may be configured to perform one or more processes described herein, such as process 600 of FIG. 6, process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for monitoring and/or generating may include various processing system components, such as a receive processor, a transmit processor, a controller/processor, a memory, or a combination thereof, of the UE described above in connection with FIG. 2.

The communication manager 1008 and/or the reception component 1002 may receive configuration information associated with an mTRP CJT PDSCH operation, wherein the configuration information is indicative of one or more unified TCIs. In some aspects, the communication manager 1008 may include one or more antennas, a modem, a controller/processor, a memory, or a combination thereof, of the UE described in connection with FIG. 2. In some aspects, the communication manager 1008 may include the reception component 1002 and/or the transmission component 1004. In some aspects, the communication manager 1008 may be, be similar to, include, or be included in, the communication manager 140 depicted in FIGS. 1 and 2.

The communication manager 1008 and/or the reception component 1002 may receive, based on the one or more unified TCIs, a CJT communication comprising a plurality of transmission layers, wherein each transmission layer of the plurality of transmission layers corresponds to each of the one or more unified TCIs. The communication manager 1008 and/or the reception component 1002 may receive a TCI activation MAC CE indicative of an activation of a TCI codepoint with at least one TCI of the one or more unified TCIs. The communication manager 1008 and/or the transmission component 1004 may transmit UE capability information indicative of the maximum TCI quantity. The communication manager 1008 and/or the reception component 1002 may monitor, based on at least one unified TCI of the one or more unified TCIs, a CORESET for a PDCCH communication.

The communication manager 1008 and/or the reception component 1002 may monitor a PDSCH based on a first communication scheme during a first time period. The communication manager 1008 and/or the reception component 1002 may monitor the PDSCH based on a second communication scheme during a second time period based on a switching condition being satisfied. The communication manager 1008 and/or the reception component 1002 may receive a TCI activation MAC CE, wherein the switching condition is satisfied based on the MAC CE.

The communication manager 1008 and/or the reception component 1002 may receive configuration information associated with an mTRP CJT physical uplink channel operation. The communication manager 1008 and/or the transmission component 1004 may generate a layer of a CJT communication, wherein the layer of the CJT communication based on a coherent precoding scheme associated with a plurality of TRPs. The communication manager 1008 and/or the transmission component 1004 may transmit the layer of the CJT communication to the plurality of TRPs.

The communication manager 1008 and/or the reception component 1002 may receive an indication of a plurality of SRIs, each SRI of the plurality of SRIs corresponding to a TRP of the plurality of TRPs, wherein transmitting the layer of the CJT communication comprises transmitting the layer of the CJT communication based on a plurality of sets of power control parameters, wherein each set of the plurality of sets of power control parameters is associated with an SRI of the plurality of SRIs. The communication manager 1008 and/or the transmission component 1004 may transmit UE capability information indicative of a maximum value, wherein the maximum value corresponds to a maximum quantity of TCIs or a maximum quantity of sets of power control parameters, and wherein a quantity of the first set of unified TCIs is less than or equal to the maximum value.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

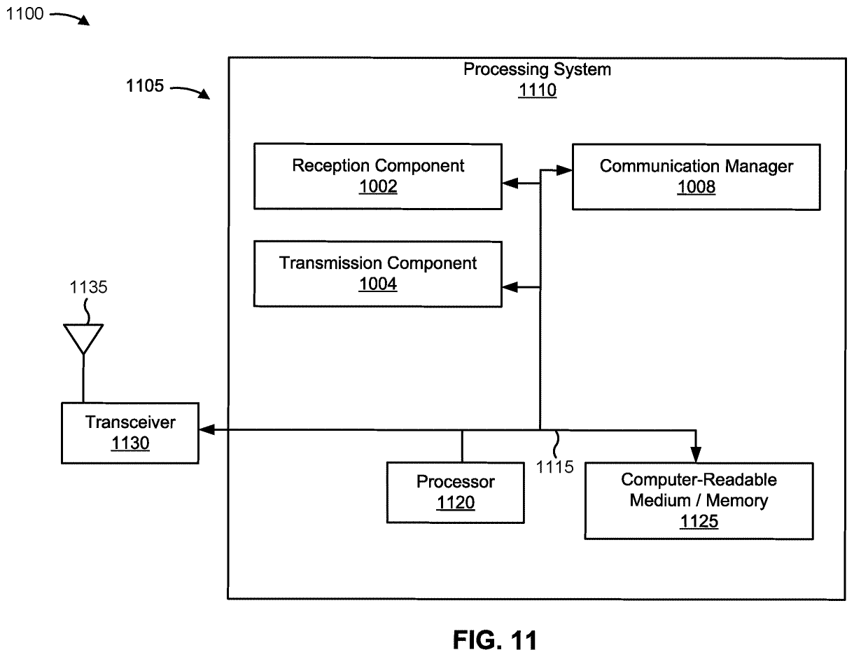

FIG. 11 is a diagram illustrating an example 1100 of a hardware implementation for an apparatus 1105 employing a processing system 1110, in accordance with the present disclosure. The apparatus 1105 may be a UE.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the UE 120 and may include the memory 282 and/or at least one of the TX MIMO processor 266, the RX processor 258, and/or the controller/processor 280. In some aspects, the apparatus 1105 for wireless communication includes means for receiving configuration information associated with an mTRP CJT PDSCH operation, wherein the configuration information is indicative of one or more unified TCIs; and receiving, based on the one or more unified TCIs, a CJT communication comprising a plurality of transmission layers, wherein each transmission layer of the plurality of transmission layers corresponds to each of the one or more unified TCIs. In some aspects, the apparatus 1105 for wireless communication includes means for receiving configuration information associated with an mTRP CJT physical uplink channel operation; generating a layer of a CJT communication, wherein the layer of the CJT communication based on a coherent precoding scheme associated with a plurality of TRPs; and transmitting the layer of the CJT communication to the plurality of TRPs. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

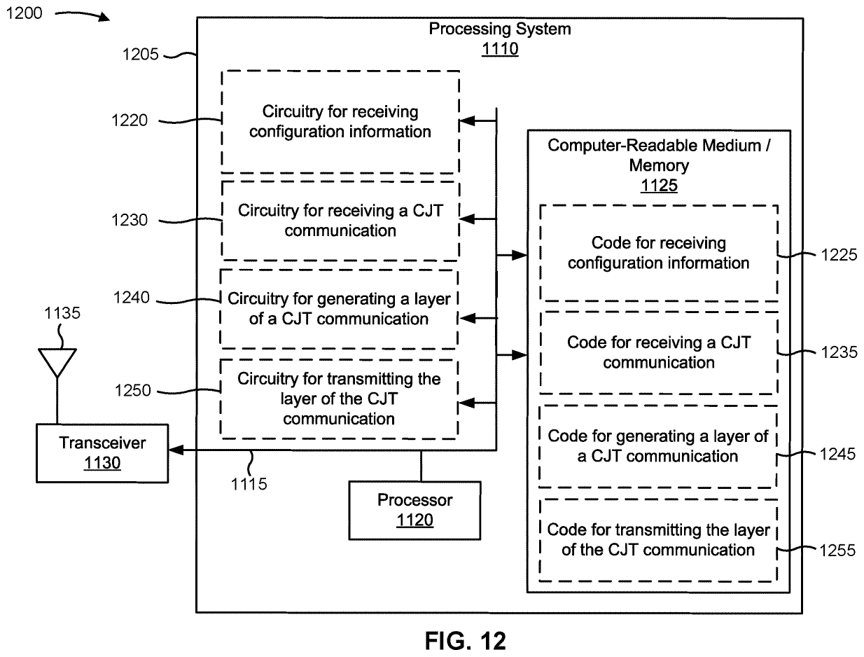

FIG. 12 is a diagram illustrating an example 1200 of an implementation of code and circuitry for an apparatus 1205, in accordance with the present disclosure. The apparatus 1205 may be a UE, or a UE may include the apparatus 1205.

As shown in FIG. 12, the apparatus 1205 may include circuitry for receiving configuration information (circuitry 1220). For example, the circuitry 1220 may enable the apparatus 1205 to receive configuration information associated with an mTRP CJT PDSCH operation, wherein the configuration information is indicative of one or more unified TCIs.

As shown in FIG. 12, the apparatus 1205 may include, stored in computer-readable medium 1125, code for receiving configuration information (code 1225). For example, the code 1225, when executed by processor 1120, may cause processor 1120 to cause transceiver 1130 to receive configuration information associated with an mTRP CJT PDSCH operation, wherein the configuration information is indicative of one or more unified TCIs. In some aspects, the code 1225, when executed by processor 1120, may cause processor 1120 to cause transceiver 1130 to receive configuration information associated with an mTRP CJT physical uplink channel operation.

As shown in FIG. 12, the apparatus 1205 may include circuitry for receiving a CJT communication (circuitry 1230). For example, the circuitry 1230 may enable the apparatus 1205 to receive, based on the one or more unified TCIs, a CJT communication comprising a plurality of transmission layers, wherein each transmission layer of the plurality of transmission layers corresponds to each of the one or more unified TCIs. In some aspects, the circuitry 1230 may enable the apparatus 1205 to receive configuration information associated with an mTRP CJT physical uplink channel operation.

As shown in FIG. 12, the apparatus 1205 may include, stored in computer-readable medium 1125, code for receiving a CJT communication (code 1235). For example, the code 1235, when executed by processor 1120, may cause processor 1120 to cause transceiver 1130 to receive, based on the one or more unified TCIs, a CJT communication comprising a plurality of transmission layers, wherein each transmission layer of the plurality of transmission layers corresponds to each of the one or more unified TCIs.

As shown in FIG. 12, the apparatus 1205 may include circuitry for generating a layer of a CJT communication (circuitry 1240). For example, the circuitry 1240 may enable the apparatus 1205 to generate a layer of a CJT communication, wherein the layer of the CJT communication based on a coherent precoding scheme associated with a plurality of TRPs.

As shown in FIG. 12, the apparatus 1205 may include, stored in computer-readable medium 1125, code for generating a layer of a CJT communication (code 1245). For example, the code 1245, when executed by processor 1120, may cause processor 1120 to generate a layer of a CJT communication, wherein the layer of the CJT communication based on a coherent precoding scheme associated with a plurality of TRPs.

As shown in FIG. 12, the apparatus 1205 may include circuitry for transmitting a layer of a CJT communication (circuitry 1250). For example, the circuitry 1250 may enable the apparatus 1205 to transmit the layer of the CJT communication to the plurality of TRPs.

As shown in FIG. 12, the apparatus 1205 may include, stored in computer-readable medium 1125, code for transmitting a layer of a CJT communication (code 1255). For example, the code 1255, when executed by processor 1120, may cause processor 1120 to cause transceiver 1130 to transmit the layer of the CJT communication to the plurality of TRPs.

FIG. 12 is provided as an example. Other examples may differ from what is described in connection with FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308.

In some aspects, the apparatus 1300 may be configured to perform one or more operations described herein in connection with FIGS. 4B and 5. Additionally, or alternatively, the apparatus 1300 may be configured to perform one or more processes described herein, such as process 700 of FIG. 7, process 900 of FIG. 9, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for generating may include various processing system components, such as a receive processor, a transmit processor, a controller/processor, a memory, or a combination thereof, of the network node described above in connection with FIG. 2.

The communication manager 1308 and/or the transmission component 1304 may transmit configuration information associated with an mTRP CJT PDSCH operation, wherein the configuration information is indicative of one or more unified TCIs. In some aspects, the communication manager 1308 may include one or more antennas, a modem, a controller/processor, a memory, or a combination thereof, of the network node described in connection with FIG. 2. In some aspects, the communication manager 1308 may include the reception component 1302 and/or the transmission component 1304. In some aspects, the communication manager 1308 may be, be similar to, include, or be included in, the communication manager 150 depicted in FIGS. 1 and 2.

The communication manager 1308 and/or the transmission component 1304 may transmit, based on the one or more unified TCIs, a CJT communication comprising a plurality of transmission layers, wherein each transmission layer of the plurality of transmission layers corresponds to each of the one or more unified TCIs. The communication manager 1308 and/or the transmission component 1304 may transmit a TCI activation MAC CE indicative of an activation of a TCI codepoint with at least one TCI of the one or more unified TCIs. The communication manager 1308 and/or the reception component 1302 may receive UE capability information indicative of the maximum TCI quantity. The communication manager 1308 and/or the transmission component 1304 may transmit a TCI activation MAC CE, wherein the switching condition is satisfied based on the MAC CE. The communication manager 1308 and/or the transmission component 1304 may transmit configuration information associated with a mTRP CJT physical uplink channel operation. The communication manager 1308 and/or the reception component 1302 may receive a layer of a CJT communication, wherein the layer of the CJT communication is based on a coherent precoding scheme associated with a plurality of TRPs, and wherein the network node comprises a TRP of the plurality of TRPs.

The communication manager 1308 and/or the transmission component 1304 may transmit an indication of a plurality of SRIs, each SRI of the plurality of SRIs corresponding to a TRP of the plurality of TRPs, wherein receiving the layer of the CJT communication comprises receiving the layer of the CJT communication based on a plurality of sets of power control parameters, wherein each set of the plurality of sets of power control parameters is associated with an SRI of the plurality of SRIs. The communication manager 1308 and/or the reception component 1302 may receive UE capability information indicative of a maximum value, wherein the maximum value corresponds to a maximum quantity of TCIs or a maximum quantity of sets of power control parameters, and wherein a quantity of the first set of unified TCIs is less than or equal to the maximum value.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

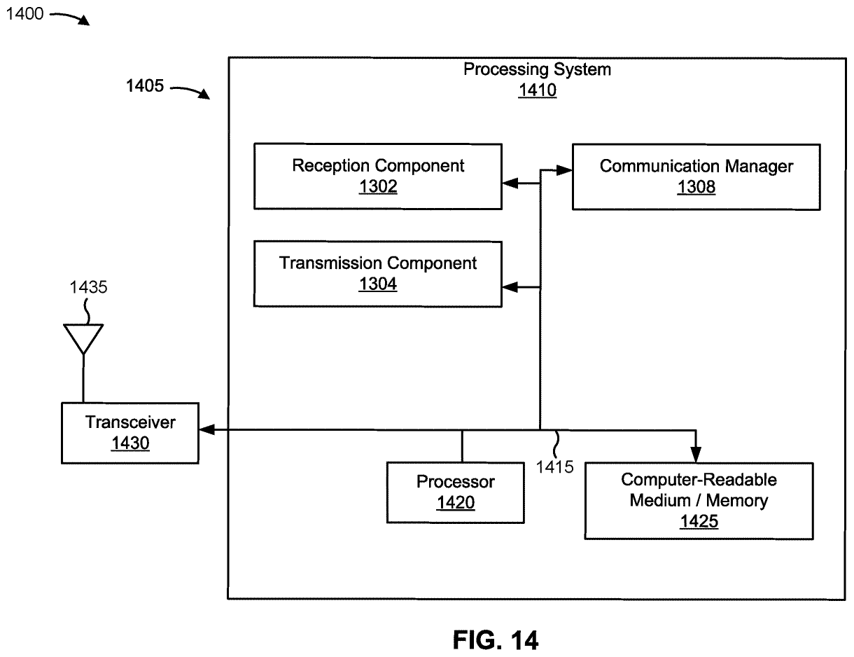

FIG. 14 is a diagram illustrating an example 1400 of a hardware implementation for an apparatus 1405 employing a processing system 1410, in accordance with the present disclosure. The apparatus 1405 may be a network node.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the network node 110 and may include the memory 242 and/or at least one of the TX MIMO processor 230, the RX processor 238, and/or the controller/processor 240. In some aspects, the apparatus 1405 for wireless communication includes means for transmitting configuration information associated with an mTRP CJT PDSCH operation, wherein the configuration information is indicative of one or more unified TCIs; and transmitting, based on the one or more unified TCIs, a CJT communication comprising a plurality of transmission layers, wherein each transmission layer of the plurality of transmission layers corresponds to each of the one or more unified TCIs. In some aspects, the apparatus 1405 for wireless communication includes means for transmitting configuration information associated with an mTRP CJT physical uplink channel operation; and receiving a layer of a CJT communication, wherein the layer of the CJT communication is based on a coherent precoding scheme associated with a plurality of TRPs, and wherein the network node comprises a TRP of the plurality of TRPs. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 14 is provided as an example. Other examples may differ from what is described in connection with FIG. 14.

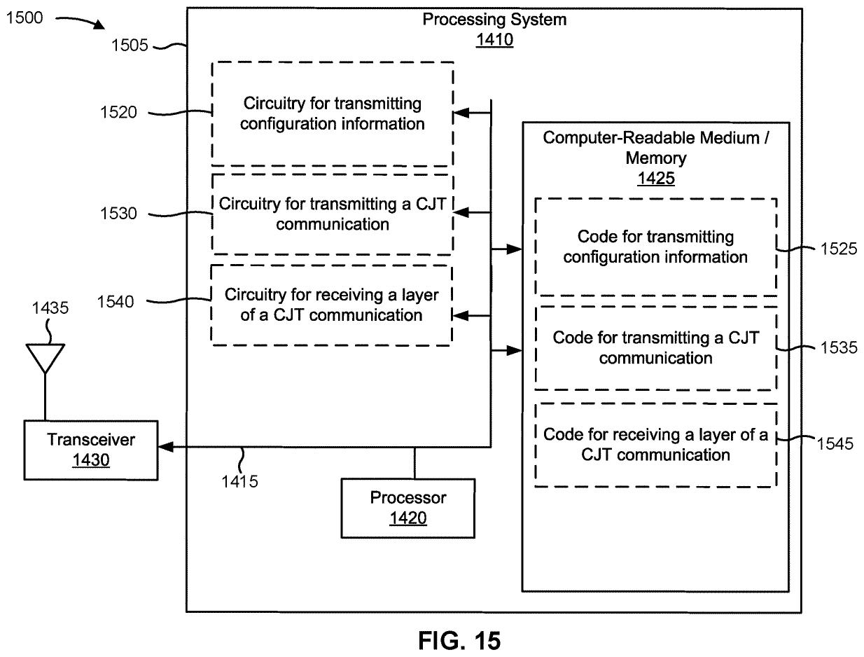

FIG. 15 is a diagram illustrating an example 1500 of an implementation of code and circuitry for an apparatus 1505, in accordance with the present disclosure. The apparatus 1505 may be a network node, or a network node may include the apparatus 1505.

As shown in FIG. 15, the apparatus 1505 may include circuitry for transmitting configuration information (circuitry 1520). For example, the circuitry 1520 may enable the apparatus 1505 to transmit configuration information associated with an mTRP CJT PDSCH operation, wherein the configuration information is indicative of one or more unified TCIs.

As shown in FIG. 15, the apparatus 1505 may include, stored in computer-readable medium 1425, code for transmitting configuration information (code 1525). For example, the code 1525, when executed by processor 1420, may cause processor 1420 to cause transceiver 1430 to transmit configuration information associated with an mTRP CJT PDSCH operation, wherein the configuration information is indicative of one or more unified TCIs.

As shown in FIG. 15, the apparatus 1505 may include circuitry for transmitting a CJT communication (circuitry 1530). For example, the circuitry 1530 may enable the apparatus 1505 to transmit, based on the one or more unified TCIs, a CJT communication comprising a plurality of transmission layers, wherein each transmission layer of the plurality of transmission layers corresponds to each of the one or more unified TCIs.

As shown in FIG. 15, the apparatus 1505 may include, stored in computer-readable medium 1425, code for transmitting a CJT communication (code 1535). For example, the code 1535, when executed by processor 1420, may cause processor 1420 to cause transceiver 1430 to transmit, based on the one or more unified TCIs, a CJT communication comprising a plurality of transmission layers, wherein each transmission layer of the plurality of transmission layers corresponds to each of the one or more unified TCIs.

As shown in FIG. 15, the apparatus 1505 may include circuitry for receiving a layer of a CJT communication (circuitry 1540). For example, the circuitry 1540 may enable the apparatus 1505 to receive a layer of a CJT communication, wherein the layer of the CJT communication is based on a coherent precoding scheme associated with a plurality of TRPs, and wherein the network node comprises a TRP of the plurality of TRPs.

As shown in FIG. 15, the apparatus 1505 may include, stored in computer-readable medium 1425, code for receiving a layer of a CJT communication (code 1545). For example, the code 1535, when executed by processor 1420, may cause processor 1420 to cause transceiver 1430 to receive a layer of a CJT communication, wherein the layer of the CJT communication is based on a coherent precoding scheme associated with a plurality of TRPs, and wherein the network node comprises a TRP of the plurality of TRPs.

FIG. 15 is provided as an example. Other examples may differ from what is described in connection with FIG. 15.

The following provides an overview of some Aspects of the present disclosure:

Aspect 1: A method of wireless communication performed by an apparatus of a user equipment (UE), comprising: receiving configuration information associated with a multiple transmission reception point (mTRP) coherent joint transmission (CJT) physical downlink shared channel (PDSCH) operation, wherein the configuration information is indicative of one or more unified transmission configuration indicators (TCIs); and receiving, based on the one or more unified TCIs, a CJT communication comprising a plurality of transmission layers, wherein each transmission layer of the plurality of transmission layers corresponds to each of the one or more unified TCIs.

Aspect 2: The method of Aspect 1, further comprising receiving a TCI activation medium access control control element indicative of an activation of a TCI codepoint with at least one TCI of the one or more unified TCIs.

Aspect 3: The method of Aspect 2, wherein the at least one TCI comprises at least one joint TCI.

Aspect 4: The method of either of Aspects 2 or 3, wherein the at least one TCI comprises at least one downlink TCI.

Aspect 5: The method of any of Aspects 2-4, wherein a quantity of the at least one TCI is less than or equal to a maximum TCI quantity.

Aspect 6: The method of Aspect 5, further comprising transmitting UE capability information indicative of the maximum TCI quantity.

Aspect 7: The method of any of Aspects 1-6, further comprising monitoring, based on at least one unified TCI of the one or more unified TCIs, a control resource set (CORESET) for a physical downlink control channel (PDCCH) communication.

Aspect 8: The method of Aspect 7, wherein the at least one unified TCI comprises a first TCI of a plurality of unified TCIs.

Aspect 9: The method of either of Aspects 7 or 8, wherein the at least one unified TCI is based on a radio resource control flag indicated by the at least one unified TCI.

Aspect 10: The method of any of Aspects 7-9, wherein the at least one unified TCI comprises each unified TCI of the one or more unified TCIs.

Aspect 11: The method of any of Aspects 7-10, wherein the at least one unified TCI is based on a radio resource control configuration indication.

Aspect 12: The method of any of Aspects 1-11, wherein the configuration information indicates at least one unified TCI of the one or more unified TCIs for monitoring a control resource set (CORESET) for a physical downlink control channel (PDCCH) communication, the method further comprising: monitoring, based on the CORESET being configured to be monitored independently of the at least one unified TCI, the CORESET based on at least one indicated TCI other than the at least one unified TCI.

Aspect 13: The method of any of Aspects 1-12, wherein receiving the CJT communication comprises receiving a first semi-persistent scheduling (SPS) physical downlink shared channel (PDSCH) communication, wherein the one or more unified TCIs comprises a first set of TCIs, the first set of TCIs consisting of a first quantity of TCIs, the method further comprising: receiving additional configuration information indicative of a second set of TCIs for the mTRP CJT PDSCH operation, the second set of TCIs consisting of a second quantity of TCIs; and receiving a second SPS PDSCH communication based on the second set of TCIs.

Aspect 14: The method of any of Aspects 1-12, wherein receiving the CJT communication comprises receiving a first semi-persistent scheduling (SPS) physical downlink shared channel (PDSCH) communication, wherein the one or more unified TCIs comprises a first set of TCIs, the first set of TCIs consisting of a first quantity of TCIs, the method further comprising: receiving additional configuration information indicative of a second set of TCIs for the mTRP CJT PDSCH operation, the second set of TCIs consisting of a second quantity of TCIs; and receiving a second SPS PDSCH communication based on the first set of TCIs.

Aspect 15: The method of any of Aspects 1-12, wherein receiving the CJT communication comprises receiving a first semi-persistent scheduling (SPS) physical downlink shared channel (PDSCH) communication, wherein the one or more unified TCIs comprises a first set of TCIs, the first set of TCIs consisting of a first quantity of TCIs, the method further comprising: receiving additional configuration information indicative of a second set of TCIs for the mTRP CJT PDSCH operation, the second set of TCIs consisting of a second quantity of TCIs; and receiving a second SPS PDSCH communication based on a third set of TCIs, wherein the third set of TCIs consists of the first quantity of TCIs.

Aspect 16: The method of Aspect 15, wherein the third set of TCIs comprises, based on the first quantity being less than or equal to the second quantity, a subset of the second set of TCIs, wherein the subset of the second set of TCIs consists of the first quantity of TCIs.

Aspect 17: The method of either of Aspects 15 or 16, wherein the third set of TCIs comprises the first set of TCIs based on the first quantity being greater than the second quantity.

Aspect 18: The method of any of Aspects 15-17, wherein receiving the second SPS PDSCH communication comprises receiving the second SPS PDSCH communication based on a default TCI codepoint.

Aspect 19: The method of Aspect 18, wherein the default TCI codepoint is a TCI codepoint, of a plurality of TCI codepoints, associated with a lowest identifier (ID) value of a plurality of ID values corresponding to of the second set of TCIs.

Aspect 20: The method of any of Aspects 1-19, further comprising: monitoring a PDSCH based on a first communication scheme during a first time period; and monitoring the PDSCH based on a second communication scheme during a second time period based on a switching condition being satisfied.

Aspect 21: The method of Aspect 20, wherein the first communication scheme or the second communication scheme corresponds to the mTRP CJT PDSCH operation.

Aspect 22: The method of Aspect 21, wherein the first communication scheme or the second communication scheme corresponds to at least one of a time division multiplexing mTRP operation, a spatial division multiplexing mTRP operation, or a single frequency network operation.

Aspect 23: The method of any of Aspects 20-22, wherein receiving the configuration information comprises receiving a radio resource control (RRC) message, and wherein the switching condition is satisfied based on the RRC message.

Aspect 25: The method of Aspect 24, wherein the configuration information configures the first communication scheme and the second communication scheme, and wherein the TCI activation MAC CE indicates the first communication scheme or the second communication scheme.

Aspect 26: The method of either of Aspects 24 or 25, wherein the TCI activation MAC CE activates two TCIs of the one or more unified TCIs for a TCI codepoint, wherein the TCI activation MAC CE includes a dedicated bit that indicates the first communication scheme or the second communication scheme.

Aspect 27: The method of any of Aspects 24-26, wherein the second communication scheme comprises the mTRP CJT PDSCH operation, and wherein the switching condition is satisfied based on the TCI activation MAC CE activating greater than two TCIs for a TCI codepoint.

Aspect 28: A method of wireless communication performed by an apparatus of a network node, comprising: transmitting configuration information associated with a multiple transmission reception point (mTRP) coherent joint transmission (CJT) physical downlink shared channel (PDSCH) operation, wherein the configuration information is indicative of one or more unified transmission configuration indicators (TCIs); and transmitting, based on the one or more unified TCIs, a CJT communication comprising a plurality of transmission layers, wherein each transmission layer of the plurality of transmission layers corresponds to each of the one or more unified TCIs.

Aspect 29: The method of Aspect 28, further comprising transmitting a TCI activation medium access control control element indicative of an activation of a TCI codepoint with at least one TCI of the one or more unified TCIs.

Aspect 30: The method of Aspect 29, wherein the at least one TCI comprises at least one joint TCI.

Aspect 31: The method of either of Aspects 29 or 30, wherein the at least one TCI comprises at least one downlink TCI.

Aspect 32: The method of any of Aspects 29-31, wherein a quantity of the at least one TCI is less than or equal to a maximum TCI quantity.

Aspect 33: The method of Aspect 32, further comprising receiving UE capability information indicative of the maximum TCI quantity.

Aspect 34: The method of any of Aspects 28-33, wherein the configuration information corresponds to a monitoring, operation based on at least one unified TCI of the one or more unified TCIs, associated with a control resource set (CORESET) for a physical downlink control channel (PDCCH) communication.

Aspect 35: The method of Aspect 34, wherein the at least one unified TCI comprises a first TCI of a plurality of unified TCIs.

Aspect 36: The method of either of Aspects 34 or 35, wherein the at least one unified TCI is based on a radio resource control flag indicated by the at least one unified TCI.

Aspect 37: The method of any of Aspects 34-36, wherein the at least one unified TCI comprises each unified TCI of the one or more unified TCIs.

Aspect 38: The method of any of Aspects 34-37, wherein the at least one unified TCI is based on a radio resource control configuration indication.

Aspect 39: The method of any of Aspects 28-38, wherein the configuration information indicates at least one unified TCI of the one or more unified TCIs for monitoring a control resource set (CORESET) for a physical downlink control channel (PDCCH) communication, wherein a monitoring operation is, based on the CORESET being configured to be monitored independently of the at least one unified TCI, associated with the CORESET based on at least one indicated TCI other than the at least one unified TCI.

Aspect 40: The method of any of Aspects 28-39, wherein transmitting the CJT communication comprises transmitting a first semi-persistent scheduling (SPS) physical downlink shared channel (PDSCH) communication, wherein the one or more unified TCIs comprises a first set of TCIs, the first set of TCIs consisting of a first quantity of TCIs, the method further comprising: transmitting additional configuration information indicative of a second set of TCIs for the mTRP CJT PDSCH operation, the second set of TCIs consisting of a second quantity of TCIs; and transmitting a second SPS PDSCH communication based on the second set of TCIs.

Aspect 41: The method of any of Aspects 28-38, wherein transmitting the CJT communication comprises transmitting a first semi-persistent scheduling (SPS) physical downlink shared channel (PDSCH) communication, wherein the one or more unified TCIs comprises a first set of TCIs, the first set of TCIs consisting of a first quantity of TCIs, the method further comprising: transmitting additional configuration information indicative of a second set of TCIs for the mTRP CJT PDSCH operation, the second set of TCIs consisting of a second quantity of TCIs; and transmitting a second SPS PDSCH communication based on the first set of TCIs.

Aspect 42: The method of any of Aspects 28-38, wherein transmitting the CJT communication comprises transmitting a first semi-persistent scheduling (SPS) physical downlink shared channel (PDSCH) communication, wherein the one or more unified TCIs comprises a first set of TCIs, the first set of TCIs consisting of a first quantity of TCIs, the method further comprising: transmitting additional configuration information indicative of a second set of TCIs for the mTRP CJT PDSCH operation, the second set of TCIs consisting of a second quantity of TCIs; and transmitting a second SPS PDSCH communication based on a third set of TCIs, wherein the third set of TCIs consists of the first quantity of TCIs.

Aspect 43: The method of Aspect 42, wherein the third set of TCIs comprises, based on the first quantity being less than or equal to the second quantity, a subset of the second set of TCIs, wherein the subset of the second set of TCIs consists of the first quantity of TCIs.

Aspect 44: The method of either of Aspects 42 or 43, wherein the third set of TCIs comprises the first set of TCIs based on the first quantity being greater than the second quantity.

Aspect 45: The method of any of Aspects 42-44, wherein transmitting the second SPS PDSCH communication comprises transmitting the second SPS PDSCH communication based on a default TCI codepoint.

Aspect 46: The method of Aspect 45, wherein the default TCI codepoint is a TCI codepoint, of a plurality of TCI codepoints, associated with a lowest identifier (ID) value of a plurality of ID values corresponding to of the second set of TCIs.

Aspect 47: The method of any of Aspects 28-46, wherein the configuration information is indicative of: a first monitoring operation associated with a PDSCH based on a first communication scheme during a first time period; and a second monitoring operation associated with the PDSCH based on a second communication scheme during a second time period based on a switching condition being satisfied.

Aspect 48: The method of Aspect 47, wherein the first communication scheme or the second communication scheme corresponds to the mTRP CJT PDSCH operation.

Aspect 49: The method of Aspect 48, wherein the first communication scheme or the second communication scheme corresponds to at least one of a time division multiplexing mTRP operation, a spatial division multiplexing mTRP operation, or a single frequency network operation.

Aspect 50: The method of any of Aspects 47-49, wherein transmitting the configuration information comprises transmitting a radio resource control (RRC) message, and wherein the switching condition is satisfied based on the RRC message.

Aspect 51: The method of any of Aspects 47-50, further comprising transmitting a TCI activation medium access control control element (MAC CE), wherein the switching condition is satisfied based on the MAC CE.

Aspect 52: The method of Aspect 51, wherein the configuration information configures the first communication scheme and the second communication scheme, and wherein the TCI activation MAC CE indicates the first communication scheme or the second communication scheme.

Aspect 53: The method of either of Aspects 51 or 52, wherein the TCI activation MAC CE activates two TCIs of the one or more unified TCIs for a TCI codepoint, wherein the TCI activation MAC CE includes a dedicated bit that indicates the first communication scheme or the second communication scheme.

Aspect 54: The method of any of Aspects 51-53, wherein the second communication scheme comprises the mTRP CJT PDSCH operation, and wherein the switching condition is satisfied based on the TCI activation MAC CE activating greater than two TCIs for a TCI codepoint.

Aspect 55: A method of wireless communication performed by an apparatus of a user equipment (UE), comprising: receiving configuration information associated with a multiple transmission reception point (mTRP) coherent joint transmission (CJT) physical uplink channel operation; generating a layer of a CJT communication, wherein the layer of the CJT communication based on a coherent precoding scheme associated with a plurality of transmission reception points (TRPs); and transmitting the layer of the CJT communication to the plurality of TRPs.

Aspect 56: The method of Aspect 55, further comprising receiving an indication of a plurality of sounding resource signal resource indicators (SRIs), each SRI of the plurality of SRIs corresponding to a TRP of the plurality of TRPs, wherein transmitting the layer of the CJT communication comprises transmitting the layer of the CJT communication based on a plurality of sets of power control parameters, wherein each set of the plurality of sets of power control parameters is associated with an SRI of the plurality of SRIs.

Aspect 57: The method of either of Aspects 55 or 56, wherein the configuration information is indicative of a first set of unified transmission configuration indicators (TCIs) for the mTRP CJT physical uplink channel operation.

Aspect 58: The method of Aspect 57, wherein the first set of unified TCIs include at least one of a joint TCI or an uplink TCI.

Aspect 59: The method of either of Aspects 57 or 58, wherein transmitting the layer of the CJT communication comprises transmitting the layer of the CJT communication based on a plurality of sets of power control parameters, each set of the plurality of sets of power control parameters corresponding to a TRP of the plurality of TRPs, wherein the first set of unified TCIs are indicative of the plurality of sets of power control parameters.

Aspect 60: The method of any of Aspects 57-59, further comprising transmitting UE capability information indicative of a maximum value, wherein the maximum value corresponds to a maximum quantity of TCIs or a maximum quantity of sets of power control parameters, and wherein a quantity of the first set of unified TCIs is less than or equal to the maximum value.

Aspect 61: The method of Aspect 60, wherein the configuration information is further indicative of a second set of unified TCIs for an mTRP CJT physical downlink channel operation.

Aspect 62: The method of Aspect 61, wherein a quantity of unified TCIs in the second set of unified TCIs is less than or equal to a difference between the maximum value and a quantity of unified TCIs in the first set of unified TCIs.

Aspect 63: The method of either of Aspects 61 or 62, wherein the maximum value corresponds to the maximum quantity of sets of power control parameters, and wherein a total quantity of TCIs in a total set of unified TCIs is greater than the maximum value, wherein the total set of unified TCIs comprises the first set of unified TCIs and the second set of unified TCIs.

Aspect 64: The method of Aspect 63, wherein transmitting the layer of the CJT communication comprises transmitting the layer of the CJT communication based on a subset of the total set of unified TCIs, wherein a quantity of TCIs in the subset is equal to the maximum value.

Aspect 65: The method of either of Aspects 63 or 64, wherein a subset of the total set of unified TCIs includes one or more TCIs indicative of the plurality of sets of power control parameters, and wherein a quantity of the one or more TCIs is equal to the maximum value.

Aspect 66: A method of wireless communication performed by an apparatus of a network node, comprising: transmitting configuration information associated with a multiple transmission reception point (mTRP) coherent joint transmission (CJT) physical uplink channel operation; and receiving a layer of a CJT communication, wherein the layer of the CJT communication is based on a coherent precoding scheme associated with a plurality of TRPs, and wherein the network node comprises a TRP of the plurality of TRPs.

Aspect 67: The method of Aspect 66, further comprising transmitting an indication of a plurality of sounding resource signal resource indicators (SRIs), each SRI of the plurality of SRIs corresponding to a TRP of the plurality of TRPs, wherein receiving the layer of the CJT communication comprises receiving the layer of the CJT communication based on a plurality of sets of power control parameters, wherein each set of the plurality of sets of power control parameters is associated with an SRI of the plurality of SRIs.

Aspect 68: The method of either of Aspects 66 or 67, wherein the configuration information is indicative of a first set of unified transmission configuration indicators (TCIs) for the mTRP CJT physical uplink channel operation.

Aspect 69: The method of Aspect 68, wherein the first set of unified TCIs include at least one of a joint TCI or an uplink TCI.

Aspect 70: The method of either of Aspects 68 or 69, wherein receiving the layer of the CJT communication comprises receiving the layer of the CJT communication based on a plurality of sets of power control parameters, each set of the plurality of sets of power control parameters corresponding to a TRP of the plurality of TRPs, wherein the first set of unified TCIs are indicative of the plurality of sets of power control parameters.

Aspect 71: The method of any of Aspects 68-70, further comprising receiving UE capability information indicative of a maximum value, wherein the maximum value corresponds to a maximum quantity of TCIs or a maximum quantity of sets of power control parameters, and wherein a quantity of the first set of unified TCIs is less than or equal to the maximum value.

Aspect 72: The method of Aspect 71, wherein the configuration information is further indicative of a second set of unified TCIs for an mTRP CJT physical downlink channel operation.

Aspect 73: The method of Aspect 72, wherein a quantity of unified TCIs in the second set of unified TCIs is less than or equal to a difference between the maximum value and a quantity of unified TCIs in the first set of unified TCIs.

Aspect 74: The method of either of Aspects 72 or 73, wherein the maximum value corresponds to the maximum quantity of sets of power control parameters, and wherein a total quantity of TCIs in a total set of unified TCIs is greater than the maximum value, wherein the total set of unified TCIs comprises the first set of unified TCIs and the second set of unified TCIs.

Aspect 75: The method of Aspect 74, wherein receiving the layer of the CJT communication comprises receiving the layer of the CJT communication based on a subset of the total set of unified TCIs, wherein a quantity of TCIs in the subset is equal to the maximum value.

Aspect 76: The method of either of Aspects 74 or 75, wherein a subset of the total set of unified TCIs includes one or more TCIs indicative of the plurality of sets of power control parameters, and wherein a quantity of the one or more TCIs is equal to the maximum value.

Aspect 77: An apparatus for wireless communication at a device, comprising a processor; memory coupled with the processor; and instructions stored in the memory and executable by the processor to cause the apparatus to perform the method of one or more of Aspects 1-27.

Aspect 78: A device for wireless communication, comprising a memory and one or more processors coupled to the memory, the one or more processors configured to perform the method of one or more of Aspects 1-27.

Aspect 79: An apparatus for wireless communication, comprising at least one means for performing the method of one or more of Aspects 1-27.

Aspect 80: A non-transitory computer-readable medium storing code for wireless communication, the code comprising instructions executable by a processor to perform the method of one or more of Aspects 1-27.

Aspect 81: A non-transitory computer-readable medium storing a set of instructions for wireless communication, the set of instructions comprising one or more instructions that, when executed by one or more processors of a device, cause the device to perform the method of one or more of Aspects 1-27.

Aspect 82: An apparatus for wireless communication at a device, comprising a processor; memory coupled with the processor; and instructions stored in the memory and executable by the processor to cause the apparatus to perform the method of one or more of Aspects 28-54.

Aspect 83: A device for wireless communication, comprising a memory and one or more processors coupled to the memory, the one or more processors configured to perform the method of one or more of Aspects 28-54.

Aspect 84: An apparatus for wireless communication, comprising at least one means for performing the method of one or more of Aspects 28-54.

Aspect 85: A non-transitory computer-readable medium storing code for wireless communication, the code comprising instructions executable by a processor to perform the method of one or more of Aspects 28-54.

Aspect 86: A non-transitory computer-readable medium storing a set of instructions for wireless communication, the set of instructions comprising one or more instructions that, when executed by one or more processors of a device, cause the device to perform the method of one or more of Aspects 28-54.

Aspect 87: An apparatus for wireless communication at a device, comprising a processor; memory coupled with the processor; and instructions stored in the memory and executable by the processor to cause the apparatus to perform the method of one or more of Aspects 55-65.

Aspect 88: A device for wireless communication, comprising a memory and one or more processors coupled to the memory, the one or more processors configured to perform the method of one or more of Aspects 55-65.

Aspect 89: An apparatus for wireless communication, comprising at least one means for performing the method of one or more of Aspects 55-65.

Aspect 90: A non-transitory computer-readable medium storing code for wireless communication, the code comprising instructions executable by a processor to perform the method of one or more of Aspects 55-65.

Aspect 91: A non-transitory computer-readable medium storing a set of instructions for wireless communication, the set of instructions comprising one or more instructions that, when executed by one or more processors of a device, cause the device to perform the method of one or more of Aspects 55-65.

Aspect 92: An apparatus for wireless communication at a device, comprising a processor; memory coupled with the processor; and instructions stored in the memory and executable by the processor to cause the apparatus to perform the method of one or more of Aspects 66-76.

Aspect 93: A device for wireless communication, comprising a memory and one or more processors coupled to the memory, the one or more processors configured to perform the method of one or more of Aspects 66-76.

Aspect 94: An apparatus for wireless communication, comprising at least one means for performing the method of one or more of Aspects 66-76.

Aspect 95: A non-transitory computer-readable medium storing code for wireless communication, the code comprising instructions executable by a processor to perform the method of one or more of Aspects 66-76.

Aspect 96: A non-transitory computer-readable medium storing a set of instructions for wireless communication, the set of instructions comprising one or more instructions that, when executed by one or more processors of a device, cause the device to perform the method of one or more of Aspects 66-76.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors coupled to the memory, the one or more processors configured to:
obtain configuration information associated with a multiple transmission reception point (mTRP) coherent joint transmission (CJT) physical downlink shared channel (PDSCH) operation, wherein the configuration information is indicative of one or more unified transmission configuration indicators (TCIs); and
obtain, based on the one or more unified TCIs, a CJT communication comprising a plurality of transmission layers, wherein each transmission layer of the plurality of transmission layers corresponds to each of the one or more unified TCIs.

2. The UE of claim 1, wherein the one or more processors are further configured to obtain a TCI activation medium access control control element (MAC CE) indicative of an activation of a TCI codepoint with at least one TCI of the one or more unified TCIs.

3. The UE of claim 2, wherein the at least one TCI comprises at least one of a joint TCI or a downlink TCI.

4. The UE of claim 2, wherein a quantity of the at least one TCI is less than or equal to a maximum TCI quantity.

5. The UE of claim 4, wherein the one or more processors are further configured to output for transmission UE capability information indicative of the maximum TCI quantity.

6. The UE of claim 1, wherein the one or more processors are further configured to monitor, based on at least one unified TCI of the one or more unified TCIs, a control resource set (CORESET) for a physical downlink control channel (PDCCH) communication.

7. The UE of claim 6, wherein the at least one unified TCI comprises a first TCI of a plurality of unified TCIs.

8. The UE of claim 6, wherein the at least one unified TCI is based on a radio resource control (RRC) flag indicated by the at least one unified TCI.

9. The UE of claim 6, wherein the at least one unified TCI comprises each unified TCI of the one or more unified TCIs.

10. The UE of claim 6, wherein the at least one unified TCI is based on a radio resource control (RRC) configuration indication.

11. The UE of claim 1, wherein the configuration information indicates at least one unified TCI of the one or more unified TCIs for monitoring a control resource set (CORESET) for a physical downlink control channel (PDCCH) communication, wherein the one or more processors are further configured to:
monitor, based on the CORESET being configured to be monitored independently of the at least one unified TCI, the CORESET based on at least one indicated TCI other than the at least one unified TCI.

12. The UE of claim 1, wherein the one or more processors, to obtain the CJT communication, are configured to obtain a first semi-persistent scheduling (SPS) physical downlink shared channel (PDSCH) communication, wherein the one or more unified TCIs comprises a first set of TCIs, the first set of TCIs consisting of a first quantity of TCIs, wherein the one or more processors are further configured to:
obtain additional configuration information indicative of a second set of TCIs for the mTRP CJT PDSCH operation, the second set of TCIs consisting of a second quantity of TCIs; and
obtain a second SPS PDSCH communication based on the second set of TCIs.

13. The UE of claim 1, wherein the one or more processors, to obtain the CJT communication, are configured to obtain a first semi-persistent scheduling (SPS) physical downlink shared channel (PDSCH) communication, wherein the one or more unified TCIs comprises a first set of TCIs, the first set of TCIs consisting of a first quantity of TCIs, wherein the one or more processors are further configured to:
obtain additional configuration information indicative of a second set of TCIs for the mTRP CJT PDSCH operation, the second set of TCIs consisting of a second quantity of TCIs; and
obtain a second SPS PDSCH communication based on the first set of TCIs.

14. The UE of claim 1, wherein the one or more processors, to obtain the CJT communication, are configured to obtain a first semi-persistent scheduling (SPS) physical downlink shared channel (PDSCH) communication, wherein the one or more unified TCIs comprises a first set of TCIs, the first set of TCIs consisting of a first quantity of TCIs, wherein the one or more processors are further configured to:
obtain additional configuration information indicative of a second set of TCIs for the mTRP CJT PDSCH operation, the second set of TCIs consisting of a second quantity of TCIs; and
obtain a second SPS PDSCH communication based on a third set of TCIs, wherein the third set of TCIs consists of the first quantity of TCIs.

15. The UE of claim 14, wherein the third set of TCIs comprises, based on the first quantity being less than or equal to the second quantity, a subset of the second set of TCIs, wherein the subset of the second set of TCIs consists of the first quantity of TCIs.

16-17. (canceled)

18. The UE of claim 1, wherein the one or more processors are further configured to:
monitor a PDSCH based on a first communication scheme during a first time period; and
monitor the PDSCH based on a second communication scheme during a second time period based on a switching condition being satisfied.

19-20. (canceled)

21. A network node for wireless communication, comprising:
a memory; and
one or more processors coupled to the memory, the one or more processors configured to:
output for transmission configuration information associated with a multiple transmission reception point (mTRP) coherent joint transmission (CJT) physical downlink shared channel (PDSCH) operation, wherein the configuration information is indicative of one or more unified transmission configuration indicators (TCIs); and
output for transmission, based on the one or more unified TCIs, a CJT communication comprising a plurality of transmission layers, wherein each transmission layer of the plurality of transmission layers corresponds to each of the one or more unified TCIs.

22. The network node of claim 21, wherein the one or more processors are further configured to output for transmission a TCI activation medium access control control element (MAC CE) indicative of an activation of a TCI codepoint with at least one TCI of the one or more unified TCIs, wherein the at least one TCI comprises at least one of a joint TCI or a downlink TCI.

23. A user equipment (UE) for wireless communication, comprising:
a memory; and
one or more processors coupled to the memory, the one or more processors configured to:
obtain configuration information associated with a multiple transmission reception point (mTRP) coherent joint transmission (CJT) physical uplink channel operation;
generate a layer of a CJT communication, wherein the layer of the CJT communication based on a coherent precoding scheme associated with a plurality of transmission reception points (TRPs); and
output for transmission the layer of the CJT communication to the plurality of TRPs.

24. The UE of claim 23, wherein the one or more processors are further configured to obtain an indication of a plurality of sounding resource signal resource indicators (SRIs), each SRI of the plurality of SRIs corresponding to a TRP of the plurality of TRPs, wherein the one or more processors, to output for transmission the layer of the CJT communication, are configured to output for transmission the layer of the CJT communication based on a plurality of sets of power control parameters, wherein each set of the plurality of sets of power control parameters is associated with an SRI of the plurality of SRIs.

25-30. (canceled)
